(19) United States
(12) Patent Application Publication
(10) Pub. No.: US 2023/0086644 A1
(43) Pub. Date: Mar. 23, 2023

(54) Cryptographically Enabling Characteristic Assignment to Identities with Tokens, Token Validity Assessments and State Capture Processes

(71) Applicant: Artema Labs, Inc, Los Angeles, CA (US)

(72) Inventors: Bjorn Markus Jakobsson, Portola Valley, CA (US); Stephen C. Gerber, Austin, TX (US); Ajay Kapur, Valencia, CA (US); Michael Leisz, Los Angeles, CA (US)

(73) Assignee: Artema Labs, Inc, Los Angeles, CA (US)

(21) Appl. No.: 17/934,146

(22) Filed: Sep. 21, 2022

Related U.S. Application Data
(60) Provisional application No. 63/246,620, filed on Sep. 21, 2021.
(60) Provisional application No. 63/247,331, filed on Sep. 23, 2021.
(60) Provisional application No. 63/257,133, filed on Oct. 19, 2021.

(51) Int. Cl. G06Q 20/36; G06Q 20/40

(52) U.S. Cl. CPC G06Q 20/367; G06Q 20/401; G06Q 2220/00

(57) ABSTRACT

In various embodiments a device can be configured to implement a distributed ledger capable of immutably recording state data to tokens. In an embodiment a device includes a network interface, memory, and a processor. The processor can be configured to obtain a token including an access policy. The access policy can include a set of access rights. The processor can be further configured to render the token description, receive a user input, and initiate an action based on the token description and the user input. The action can include accessing the content using the access policy. The processor can be further configured to generate a transaction record, and to broadcast the transaction record, the transaction record configured to be incorporated into a ledger entry. The ledger entry capable of being used to compute a challenge for securely adding the ledger entry to a distributed ledger using a cryptographic system.

### CROSS-REFERENCE TO RELATED APPLICATIONS

The current application claims the benefit of and priority under 35 U.S.C. § 119(e) to U.S. Provisional Patent Application No. 63/246,620 filed Sep. 21, 2021 titled “State Capture Method”, U.S. Provisional Patent Application No. 63/247,331 filed Sep. 23, 2021 titled “Token Validity Assessment Technology”, and U.S. Provisional Patent Application No. 63/257,133 filed Oct. 19, 2021 titled “Characteristic Assignment to Identities with Tokens”, the disclosures of which are incorporated herein by reference in their entireties for all purposes.

### FIELD OF THE INVENTION

This invention relates to cryptography. More particularly, it relates to accessing content based on tokens and securely modifying access rights.

### BACKGROUND

Cryptography can be used to provide security, privacy and authenticity to transactions. Some cryptographic components, such as digital signatures and encryption functions, are standardized and well-studied with known security characteristics. Cryptography can be used to create immutable ledgers such as (but not limited to) blockchains. Immutable ledgers and blockchains can be based on a variety of cryptographic methods. In some implementations of immutable ledgers and blockchains, mining is used to securely add information. Mining can include computer systems (often referred to as “miners”) generating proofs based on computational challenges. Generally, a proof can be an output of a function that conforms to one or more requirements defined by a challenge. A proof protocol can be a function used to generate a proposed proof. The proof protocol can be iteratively performed until a proof is generated which meets the requirements of the challenge. The requirements of the challenge can be based on a difficulty. Mining can also include the use of computer systems known as “verifiers” that perform processes to check the generated proofs. In many instances, a proof can be easily verified based on providing successful inputs to a verifier. Miners and verifies can be implemented using any one or more of personal computers, application-specific integrated circuits, mobile devices (e.g. a mobile phone or tablet), server computer systems, virtual machines executing on computer systems, and/or any other form of computing device capable of performing computations associated with the performance of a particular mining or verifier function.

### SUMMARY OF THE INVENTION

In various embodiments a device can be configured to implement a distributed ledger capable of immutably recording state data to tokens. In an embodiment a device includes a network interface, memory, and a processor. The processor configured to obtain a token. The token including a token description, the token description based on state data captured from an application. The token further including an access policy. The access policy including a set of access rights. The set of access rights enabling access to content, wherein the set of access rights and the content are based on the state data captured from the application. The processor further configured to render the token description, receive a user input, and initiate an action based on the token description and the user input, wherein the action includes accessing the content using the set of access rights associated with the token. The processor further configured to generate a transaction record. The transaction record including an indication of the action and the token. The processor further configured to broadcast the transaction record, the transaction record configured to be incorporated into a ledger entry. The ledger entry is capable of being used to compute a challenge for securely adding the ledger entry to a distributed ledger using a cryptographic system.

In another embodiment, the token is obtained by generating the token.

In a further embodiment, the token is obtained by receiving the token.

In an additional embodiment, the processor is further configured to detect a trigger.

In some other embodiment, the processor is further configured to detect a trigger, and wherein the action is initiated further based on the detection of the trigger.

In still another embodiment, the processor is further configured to detect a trigger, wherein the trigger is satisfied based on an application state.

In a still further another embodiment, the processor is further configured to detect a trigger, and the trigger is identified using a proximity determination.

In a still additional embodiment, the processor is further configured to detect a trigger, and the trigger is identified using a proximity determination proximity that is based on at least one item selected from a list of a GPS location being read, a Bluetooth radio signal being detected, or detection using a near field communication (NFC) sensor.

In still some other embodiment, the processor if further configured to detect a trigger, and wherein the trigger is a user-initiated request.

In yet another embodiment, the processor if further configured to detect a trigger, and wherein the trigger is an in-game achievement.

In a yet further embodiment, the state data represents a game highlight segment.

In a yet additional embodiment, the state data represents aspects of a game character.

In yet some other embodiment, the state data represents a game achievement.

In still yet another embodiment, the state data comprises a movie.

In a still yet further embodiment, the state data comprises an achievement.

In a still yet additional embodiment, the state data comprises a game configuration.

In still yet some other embodiment, the state data is encrypted.

In another still further embodiment, the state data is authenticated.

In another still additional embodiment, capturing of state data comprises accessing data using an API.

In another yet further embodiment, capturing of state data comprises accessing a record associated with a game character.

In another yet additional embodiment, the access policy further comprises a public key associated with a user allowed to access at least a portion of the content.

In another still yet further embodiment, the access policy further comprises a public key associated with a user allowed to enable access to at least a portion of the content.

In another still yet additional embodiment, the access policy further comprises an indication of a role of a user allowed to access at least a portion of the content.

In another yet still further embodiment, the content is rendered in an interface of a social networking application.

In another yet still additional embodiment, the content is rendered in an interface of a wallet application.

In another embodiment again, the content is rendered in a browser.

In a further embodiment again, a log is generated in response to the access of the content.

In some other embodiment again, a log is generated in response to the access of the content, and wherein the log is transmitted to an entity associated with the token.

In an additional embodiment again, the content is stored in a container, the container associated with the token.

In yet another embodiment again, the content is stored in a container, the container associated with the token and the container comprising a multiplicity of elements that can be rendered independently of each other.

In still another embodiment again, the content is stored in a container, the container associated with the token and the container comprising a token.

In still yet another embodiment again, the content is stored in a container, the container associated with the token and the container comprising a non-fungible token (NFT).

In yet a further embodiment again, state data is captured by selecting one or more data items.

In yet still a further embodiment again, the token description is generated based on selecting qualitative labels from a list.

In some embodiments, a device can be configured to display content based on tokens with token descriptions based on state data. In an embodiment the device includes a network interface, a display, memory, and a processor. The processor can be configured to obtain a token in a smart wallet, the smart wallet associated with a user. The token including a token description, the token description based on state data captured from an application. The token further including an access policy. The access policy including a set of access rights, the set of access rights enabling access to token content associated with the token, wherein the set of access rights and the token content are determined based on the state data captured from the application. The processor further configured to receive location data, the location data associated with the user, and display selected content. The selected content selected based on the token description, the set of access rights, the token content and the location data.

In another embodiment, the token is obtained by generating the token.

In a further embodiment, the token is obtained by receiving the token.

In some other embodiment, the processor is further configured to detect a trigger.

In an additional embodiment, the processor is further configured to detect a trigger, and wherein displaying selected content is further based on detection of the trigger.

In still another embodiment, the processor is further configured to detect a trigger, wherein the trigger is satisfied based on an application state.

In yet another embodiment, the processor is further configured to detect a trigger, and the trigger is identified using a proximity determination.

In still a further embodiment, the processor is further configured to detect a trigger, and the trigger is identified using a proximity determination proximity that is based on at least one item selected from a list of a GPS location being read, a Bluetooth radio signal being detected, or detection using a near field communication (NFC) sensor.

In yet a further embodiment, the location data is based on GPS location data.

In still some other embodiment, the location data is based on a Bluetooth radio signal.

In yet some other embodiment, the location data is based on a near field communication (NFC) sensor.

In a yet additional embodiment, the processor if further configured to detect a trigger, and wherein the trigger is a user-initiated request.

In a still additional embodiment, the processor if further configured to detect a trigger, and wherein the trigger is an in-game achievement.

In another further embodiment, the state data is encrypted.

In another additional embodiment, capturing of state data comprises accessing data using an API.

In still another further embodiment, capturing of state data comprises accessing a record associated with a game character.

In yet another further embodiment, the access policy further comprises a public key associated with a user allowed to access at least a portion of the token content.

In still another additional embodiment, the access policy further comprises a public key associated with a user allowed to enable access to at least a portion of the token content.

In yet another additional embodiment, the access policy further comprises an indication of a role of a user allowed to access at least a portion of the token content.

In still yet another embodiment, the selected content is rendered in an interface of a social networking application.

In still yet another additional embodiment, the selected content is rendered in an interface of a wallet application.

In still yet another further embodiment, the selected content is rendered in a browser.

In another embodiment again, a log is generated in response to the access of the selected content.

In an additional embodiment again, a log is generated in response to the access of the selected content, and wherein the log is transmitted to an entity associated with the token.

In some other embodiment again, the token content is stored in a container, the container associated with the token.

In a further embodiment again, the token content is stored in a container, the container associated with the token and the container comprising a multiplicity of elements that can be rendered independently of each other.

In still another embodiment again, the token content is stored in a container, the container associated with the token and the container comprising a second token.

In yet another embodiment again, the token content is stored in a container, the container associated with the token and the container comprising a non-fungible token (NFT).

In some embodiments, a device can be configured to implement an immutable ledger with filtering means based on reputation scores for content stored on the immutable ledger. In an embodiment, the device includes a network interface, memory, and a processor. The processor configured to receive information from a first user. The information including a content item, an indication identifying a first identity token. The first identity token associated with the first user and wherein the first identity token is associated with a first public key and a first score. The information further including an indication identifying a claim token, wherein the claim token references a second identity token associated with a second use. The second identity token is associated with a second public key and a second score. The processor further configured to generate a transaction record. The transaction record includes a reference to the content, a reference to the first identity token, a reference to the claim token, and a reference to the second identity token. The processor further configured to broadcast the transaction record. The transaction record configured to be incorporated into a ledger entry. The ledger entry is capable of being used to compute a challenge for securely adding the ledger entry to a distributed ledger using a cryptographic system.

In another embodiment, the first identity token is securely identified using a first pseudonym token.

In still another embodiment, the second identity token is securely identified using a second pseudonym token.

In yet another embodiment, the content comprises a text element.

In a further embodiment, the content comprises an image element.

In an additional embodiment, the content comprises an audio element.

In some other embodiment, the content comprises an executable element.

In another embodiment, the claim token is a non-fungible token (NFT).

In a yet further another embodiment, the claim token is associated with a third score.

In a still further embodiment, the claim token is associated with a claim transaction recorded on the distributed ledger.

In a yet additional embodiment, the claim token is associated with a claim transaction recorded on the distributed ledger, the claim transaction comprising a transfer of tokens.

In a still additional embodiment, the claim token comprises at least one type assessment.

In yet some other embodiment, the processor is further configured to block the content from being received by a second user based on an item selected from a list of the first score and the second score.

In still some other embodiment, the processor is further configured to block the content from being received by a second user based on comparing an item selected from a list of the first score and the second score with a threshold value.

In yet still another embodiment, the processor is further configured to receive an assessment from an authority, and wherein generating the transaction record is based on the assessment.

In another embodiment again, the transaction record further comprises a transfer of tokens to the first user.

In some embodiments, a device can be configured to implement an immutable ledger enabling token based conditional access rights for content. In an embodiment, the device includes a network interface, memory, and a processor. The processor configured to identify a first token, the first token stored in a wallet. The processor further configured to identify a second token, the second token stored in the wallet. The processor further configured to determine a combinability of the first token and the second token, and generate a transaction record. The transaction record includes minting a third token. The third token includes a policy. The policy is determined based on the combinability of the first token and the second token, the policy providing a set of access rights to a content item. The processor further configured to broadcast the transaction record. The transaction record configured to be incorporated into a ledger entry. The ledger entry is capable of being used to compute a challenge for securely adding the ledger entry to a distributed ledger using a cryptographic system.

In another embodiment, the first token comprises a first access policy comprising a first set of access rights, the first set of access rights enabling access to first content associated with the first token.

In yet another embodiment, the second token comprises a second access policy comprising a second set of access rights, the second set of access rights enabling access to second content associated with the second token.

In still another embodiment, the third token comprises a third access policy comprising a third set of access rights, the third set of access rights enabling access to third content associated with the third token.

In another embodiment again, determining a combinability of the first token and the second token comprises referencing a list received from a wallet.

In still yet another embodiment, determining a combinability of the first token and the second token comprises referencing a list accessed from the distributed ledger.

In still another embodiment again, the transaction record further comprises a record disabling access to the first token and the second token.

In yet another embodiment again, the wallet is associated with a first public key.

In still yet another embodiment again, the wallet is associated with a first public key, and the third token is minted to the first public key.

In a further embodiment, a prediction is generated based on the third token, and on a behavior associated with the wallet, wherein the prediction identifies a badge that the wallet is likely to be granted.

In a yet further embodiment, a prediction and associated confidence interval is generated based on the third token, and on a behavior associated with the wallet, wherein the prediction identifies a fourth token that the wallet is likely to be granted.

In a still further embodiment, a prediction is generated based on the third token, and on a behavior associated with the wallet using an item selected from a list of a statistical engine, a machine learning engine and an artificial intelligence engine, wherein the prediction identifies a fourth token that the wallet is likely to be granted.

In a further embodiment again, a prediction is generated based on the third token, and on a behavior associated with the wallet wherein the behavior can include an in-application purchase, and wherein the prediction identifies a fourth token that the wallet is likely to be granted.

In a yet still further embodiment, a prediction is generated based on the third token, and on a behavior associated with the wallet wherein the behavior can include an in-application action, and wherein the prediction identifies a fourth token that the wallet is likely to be granted.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention.

FIGS. 10-12 depicts various devices that can be utilized alongside an NFT platform in accordance with various embodiments of the invention.

FIG. 13 depicts a media wallet application configuration in accordance with an embodiment of the invention.

FIGS. 14A-14C depicts user interfaces of various media wallet applications in accordance with a number of embodiments of the invention.

FIG. 15 illustrates an NFT ledger entry corresponding to an NFT identifier.

FIGS. 16A-16B illustrate an NFT arrangement relationship with corresponding physical content in accordance with an embodiment of the invention.

FIG. 17 illustrates a process for establishing a relationship between an NFT and corresponding physical content.

FIG. 18 conceptually illustrates an example state capture and token generation process.

FIG. 19 conceptually illustrates an example process for user interaction with a badge representing captured state data.

FIG. 20 conceptually illustrates an example process for a transfer of ownership of a token in response to a bid.

FIG. 21 conceptually illustrates an example process for rendering of qualitative and quantitative data associated with a captured state.

FIG. 22 conceptually illustrates an example system for displaying promotional content based upon one or more tokens, a smart wallet on a smart device, location awareness, and/or APIs capable of retrieving information.

FIG. 23 conceptually illustrates an example process for applying tokens to items.

FIG. 24 conceptually illustrates an example process for applying claim tokens to items.

FIG. 25 conceptually illustrates an example process for retracting a claim token.

FIG. 26 conceptually illustrates an example process for bounty hunters to review published content for rewards.

FIG. 27 conceptually illustrates an example system for tying recognition badge achievements by an organization to a user's identity.

FIG. 28 conceptually illustrates a process for combining two tokens from two organizations into one or more new tokens.

FIG. 29 conceptually illustrates an example process using portable and reusable recognition badges within two or more entities.

FIG. 30 conceptually illustrates an example process for using redeemable recognition badges in the form of tokens.

FIG. 31 conceptually illustrates an example process for the prediction of potential future badge awards.

### DETAILED DESCRIPTION

Typical traditional non-fungible tokens (NFTs) represent static artworks. Dynamic artworks and content representing experiences have not been explored in the context of token creation and management, resulting in severe limitations of potential functionality to applications such as games. This shortcoming stifles interaction between gaming environments and NFT marketplaces, and holds back possibilities related to the promotion of game-related materials, and advanced user experiences. Furthermore, interoperability of tokens with social media platforms is rudimentary, and constrained by an absence of secure techniques to transfer gaming data between users, whether such data corresponds to experiences, capabilities or achievements. In accordance with some embodiments of the invention, tokens (NFTs) can be transferable between various environments (e.g., applications, platforms, games, social media). In several embodiments, tokens can store state data. The state data can be received from environments (e.g., applications, platforms, games, social media) associated with generation of tokens. Fake news is a significant and escalating problem for society. Fake news can relate generally to untrue statements or representations, whether text-based, image, audio or video-based. It has been found that many times, fake news spreads faster than truthful news.

Fake news is a big problem on social media platforms. Fake news can be distributed on social media platforms. In various embodiments, processes can be used to address fake news. In some embodiments, tokens can be associated with content (e.g., news). Associated tokens (e.g., identity tokens) in accordance with several embodiments of the invention can include reputation score associated with the content's creator(s). In various embodiments, content can include claims that cite sources. In various embodiments, the claims and/or sources associated with content can be linked to tokens. In many embodiments, claim tokens can include reputation scores related to claims. Source tokens (e.g., source identity tokens) in accordance with numerous embodiments of the invention can include reputation scores related to sources. In some embodiments, the reputation scores, and/or the tokens associated with content and/or claims can be used in filtering, searching, and/or rating systems.

Digital recognition badges are generally awarded by a company or organization to individuals. Some digital recognition badges may merely provide the limited benefit of being able to display the badge in a user's electronic profile. The badges are often assigned arbitrarily at the whim of the corporate entity, tied only to a corporate database, not redeemable for future benefits, not portable, not combinable, and weakly tied to the individual's identity. The usefulness of such badges is unfortunately weak.

In accordance with various embodiments of the invention, processes can enable the semi-permanent and permanent storage of tokens on public decentralized networks. Existing achievement recognition badges and loyalty systems reside within centralized networks typically controlled by the awarding organization or issuer. Publicly stored tokens can be perceived as more useful and valuable than those controlled solely by the issuer. For example, tokens from two or more issuers can interact within a user's wallet or within 3rd-party trusted execution environments. Such interactions between tokens controlled separately by different issuers is unreliable and subject to the arbitrary decisions and/or incompatibilities of one or more issuers and their associated centralized systems.

Content can be cryptographically protected. In various embodiments, tokens can facilitate access rights to content. Access rights can be determined based on policies associated with tokens. Tokens as described herein can be associated with various access rights. When tokens are combined and/or otherwise modified the content access rights conveyed to token holders can be changed.

### Non-Fungible Token (NFT) Platforms

Turning now to the drawings, systems and methods for implementing blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators can issue NFTs to users within the NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFTs minted using NFT platforms in accordance with various embodiments of the invention can have multifunctional programmable use cases including rewards, private access to premium content and experiences, as discounts toward the purchase of goods, among many other value-added use cases.

In many embodiments, each NFT can have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs can be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In many embodiments, the NFT platform can include media wallet applications that enable users to securely store NFTs and/or other tokens on their devices. Furthermore, media wallets (also referred to as “digital wallets”) can enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users can download and install media wallet applications to store NFTs on the same computing devices used to consume streamed and/or downloaded content. Media wallet applications and NFTs can disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

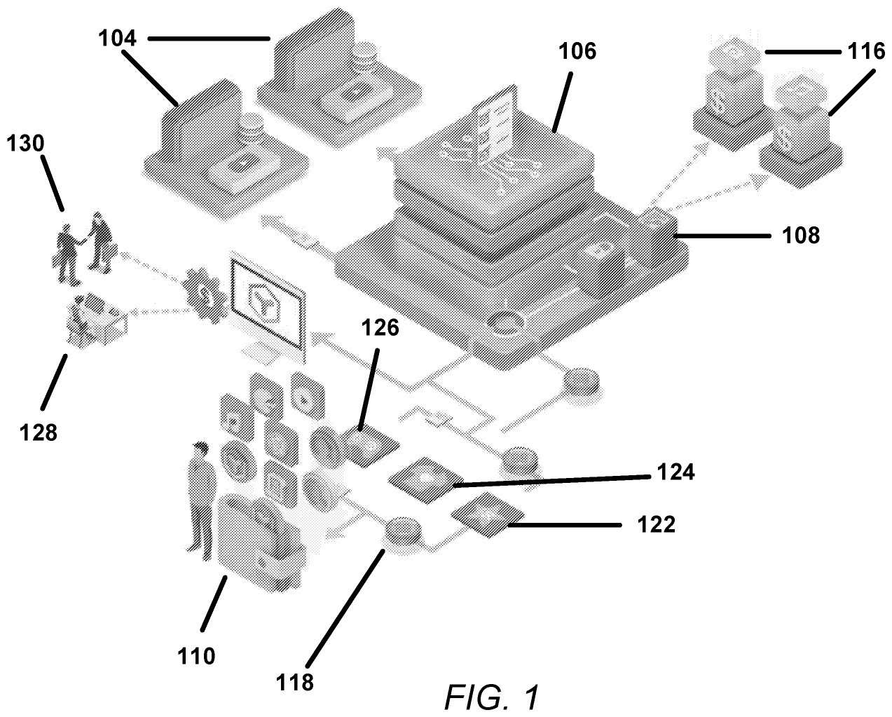

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users can be content creators that are vetted by an administrator of networks that may be responsible for deploying and maintaining the NFT blockchain. Once the NFTs are minted, users can obtain and conduct transactions with the NFTs. In several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens can be fully converted into fiat currency and/or other cryptocurrency. In several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users 128. In addition, content creators can directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the user. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications can request authentication of the NFT directly based upon the public key of the content creator and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain can be in the form of distributed ledgers, while the blockchain may alternatively be centralized in a single entity.

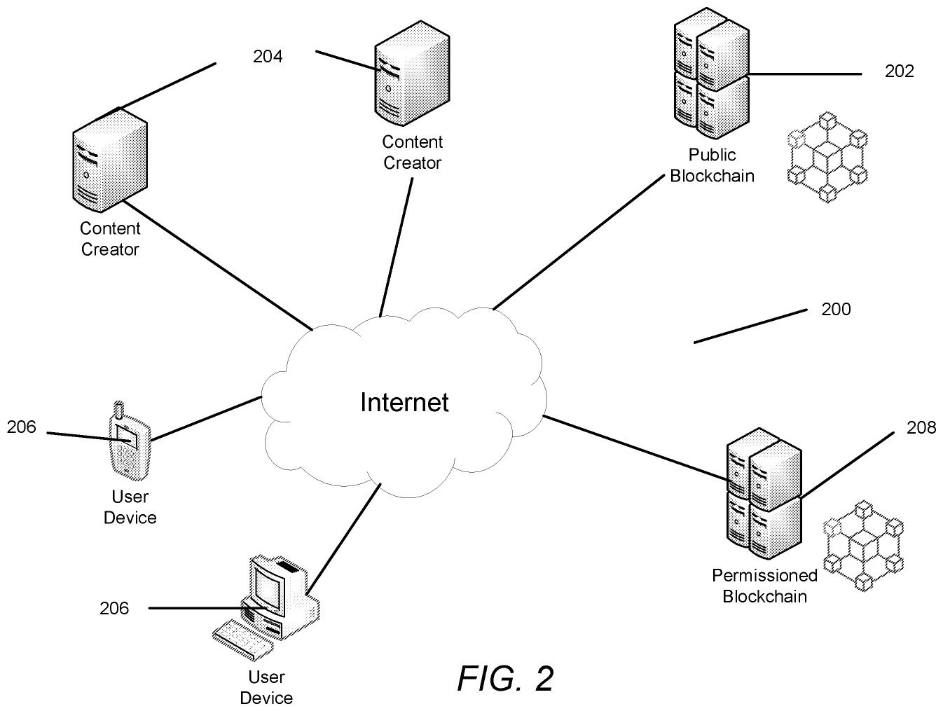

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data can be accessed by the media wallet application. In this way, users control access to entries in the permissioned blockchain 208 describing the user's NFT transaction. In several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users can utilize a media wallet application to modify permissions granted by way of the access control list. In many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In several embodiments, the access to the data is determined by computer systems that implement permission-based data access services.

In many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

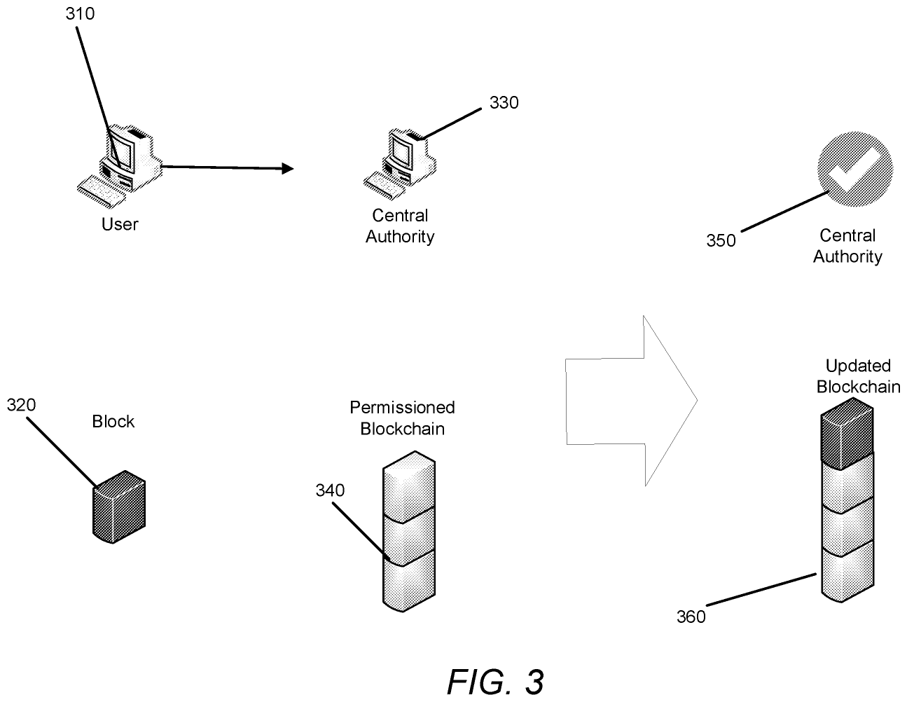

An implementation of permissioned (or private) blockchains in accordance with some embodiments of the invention is illustrated in FIG. 3. Permissioned blockchains 340 can typically function as closed computing systems in which each participant is well defined. In several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

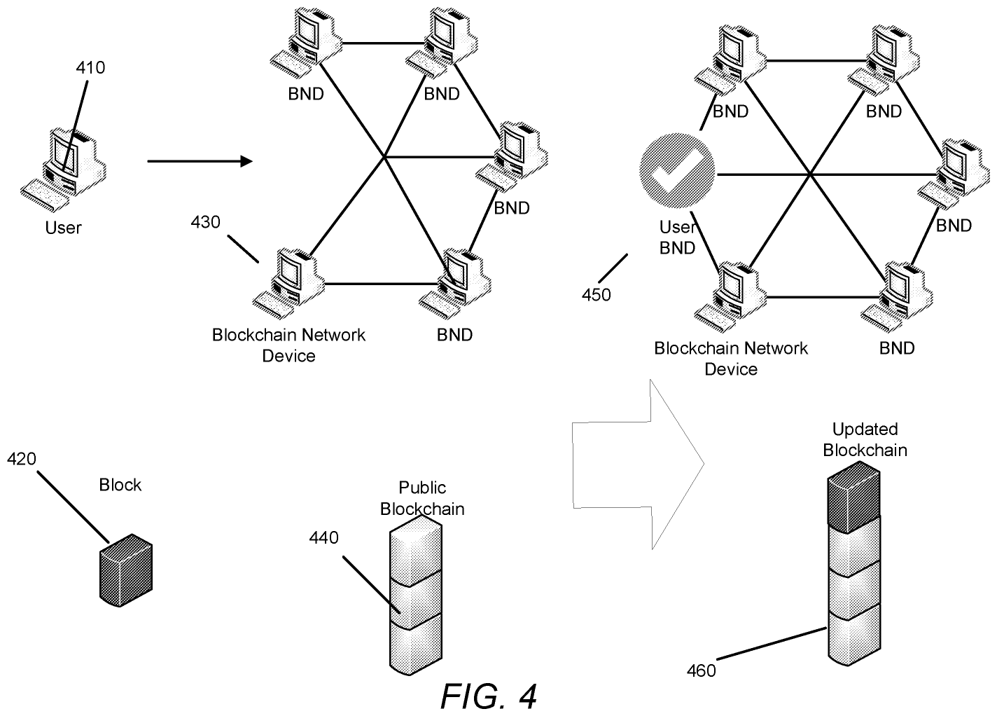

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

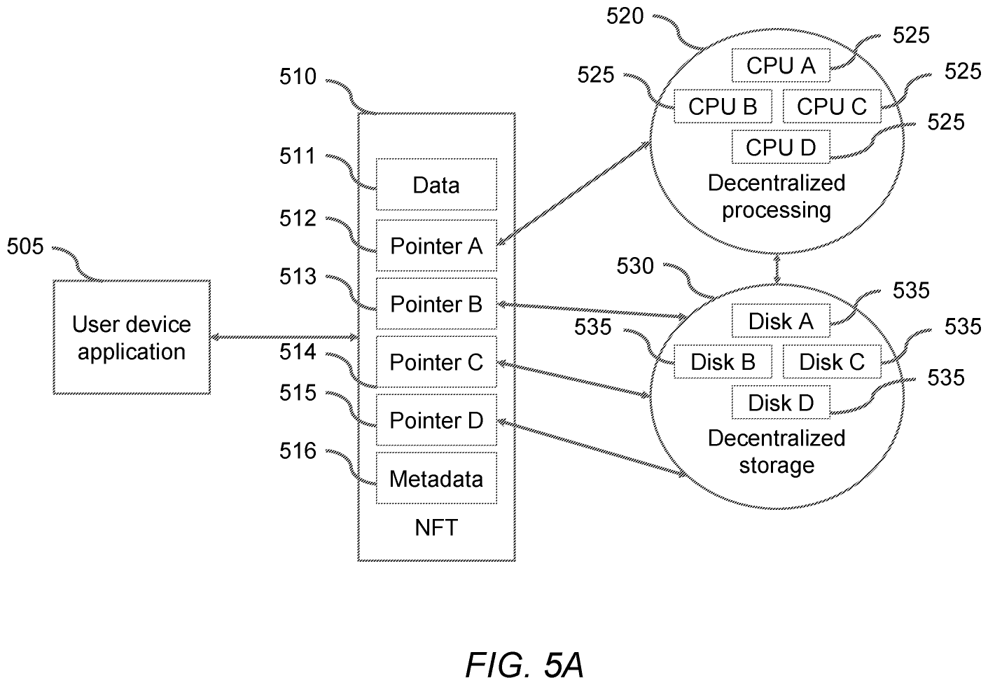

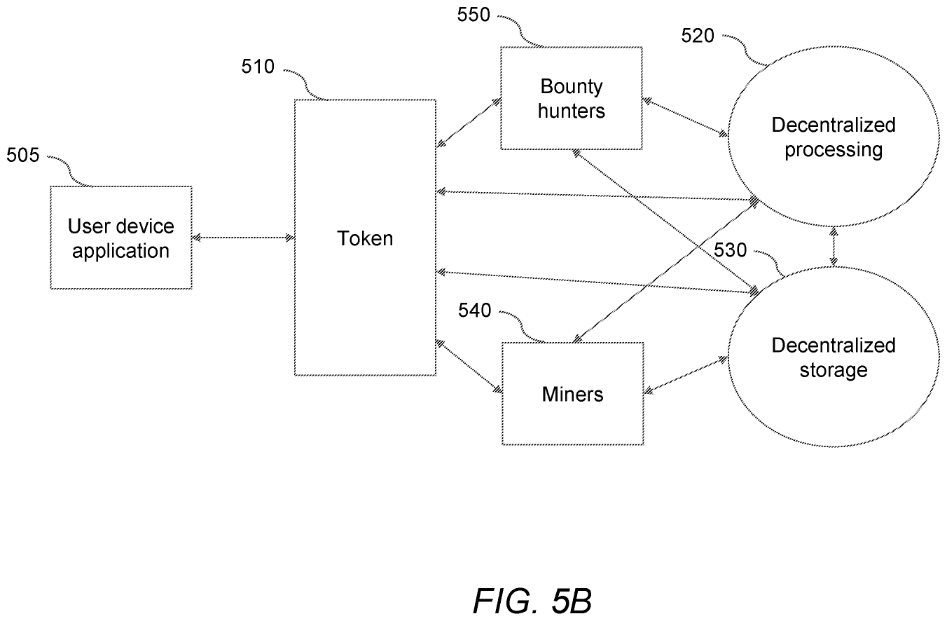

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platform Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

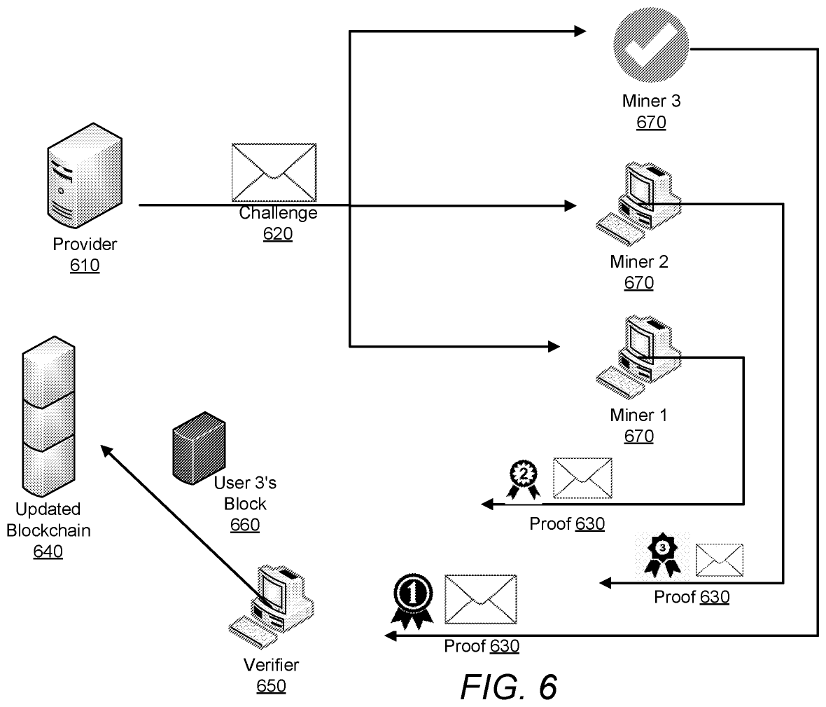

An example of Proof of Work consensus mechanisms that may be implemented in decentralized blockchains, in accordance with a number of embodiments of the invention, is conceptually illustrated in FIG. 6. The example disclosed in this figure is a challenge-response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

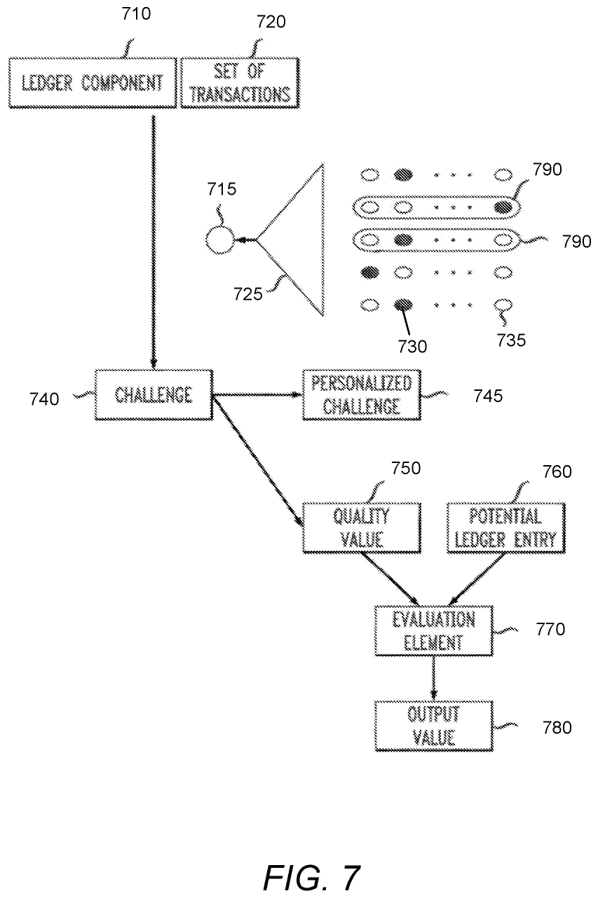

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 can also correspond to public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

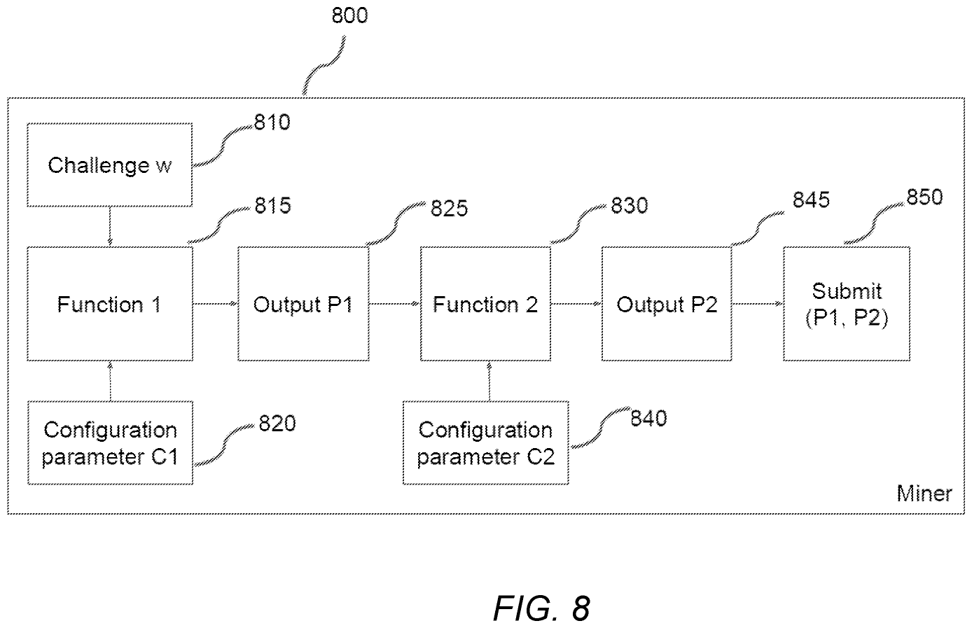

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

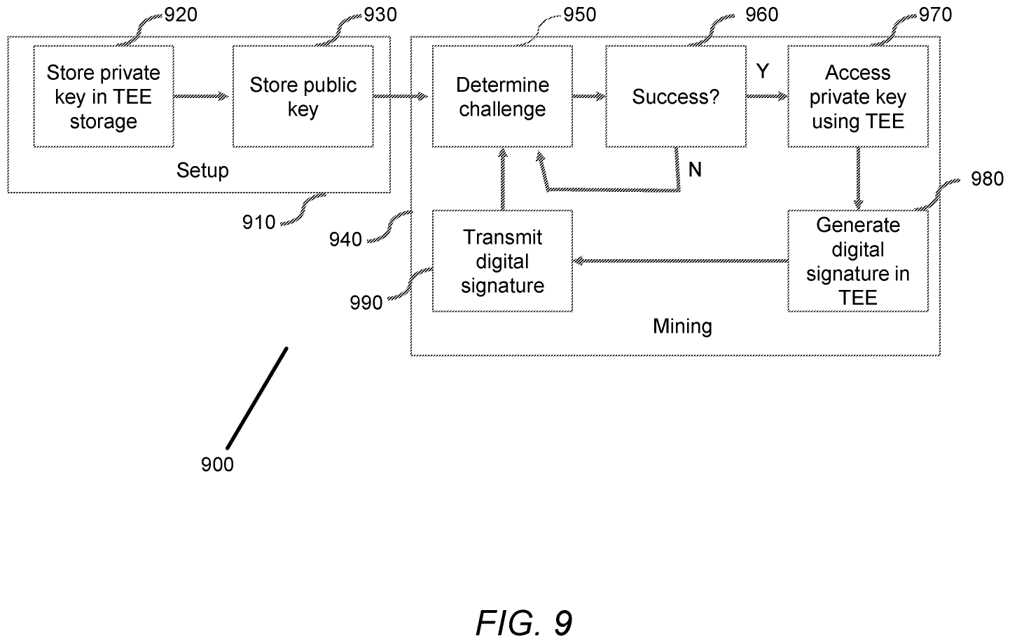

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

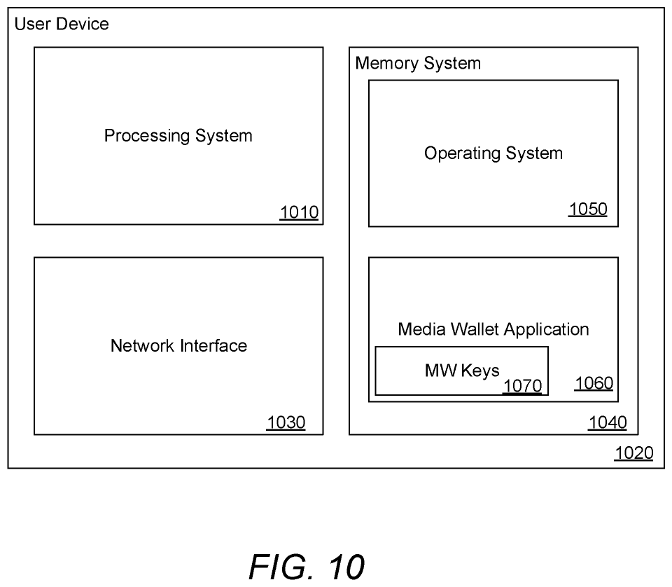

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

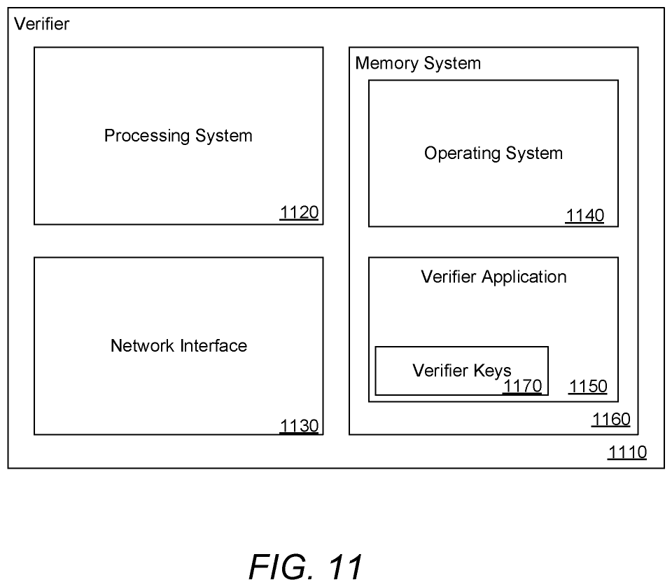

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

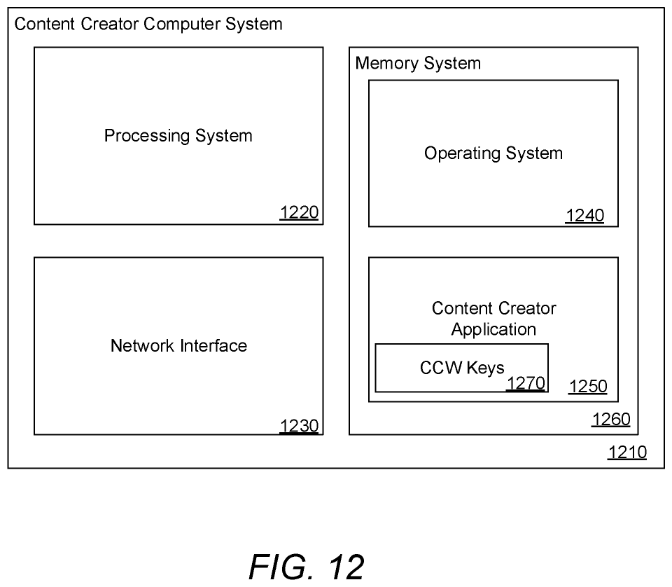

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

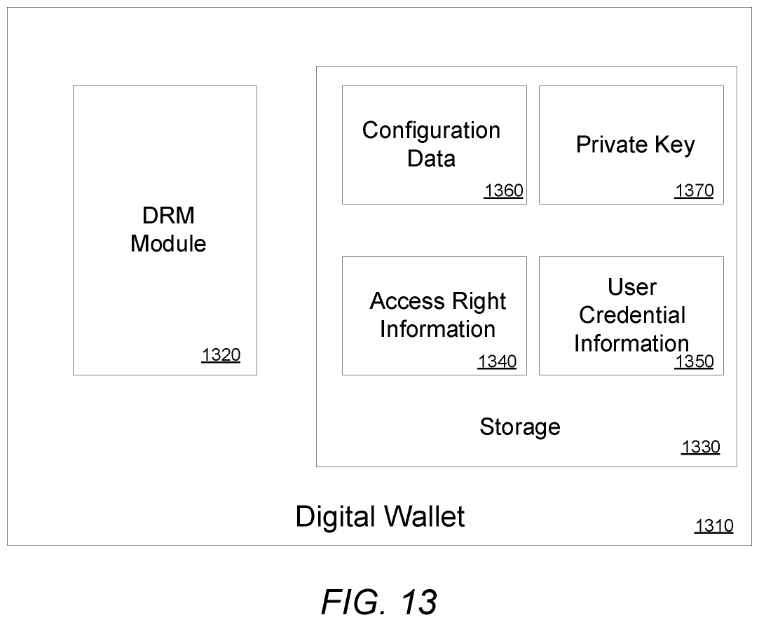

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

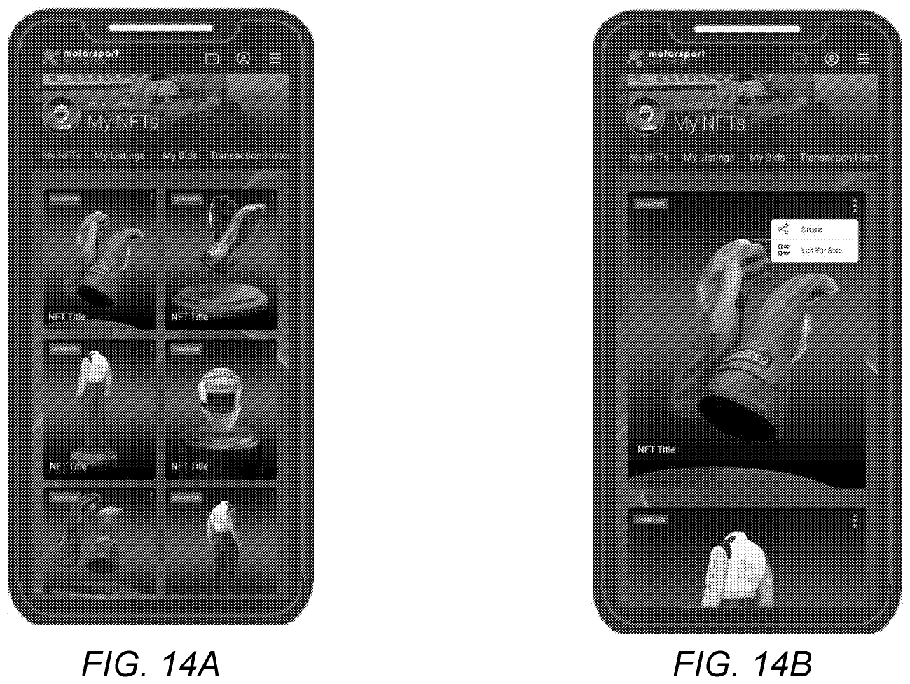

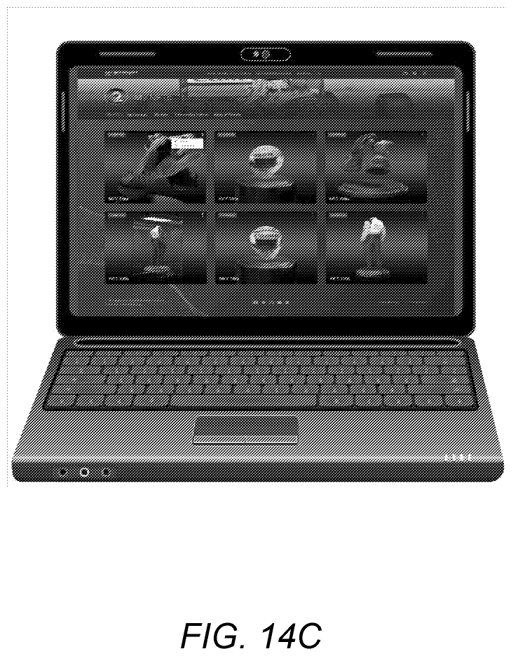

Operation of media wallet applications implemented in accordance with some embodiments of the invention is conceptually illustrated by way of the user interfaces shown in FIGS. 14A-14C. In many embodiments, media wallet applications can refer to applications that are installed upon user devices such as (but not limited to) mobile phones and tablet computers running the iOS, Android and/or similar operating systems. Launching media wallet applications can provide a number of user interface contexts. In many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In several embodiments, a first user interface context is a dashboard (see, FIGS. 14A, 14C) that can include a gallery view of NFTs owned by the user. In several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14C can be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

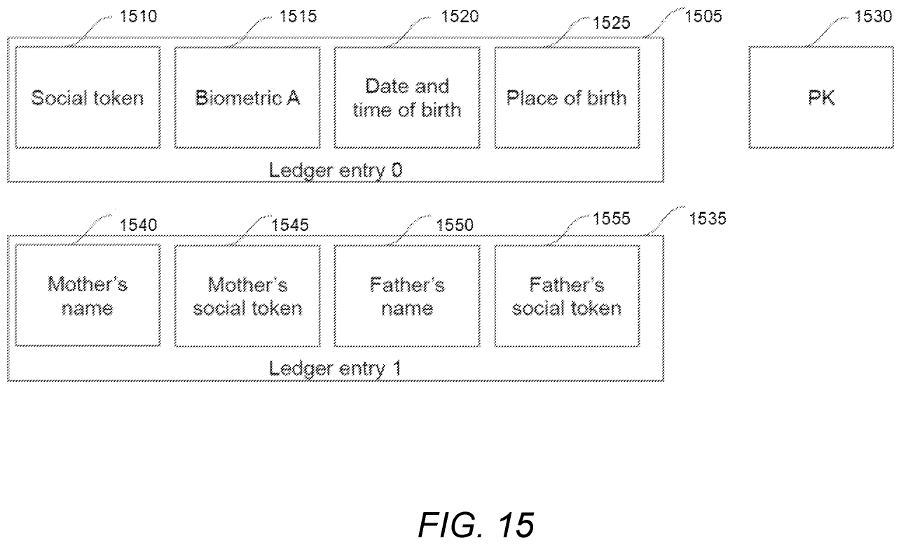

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

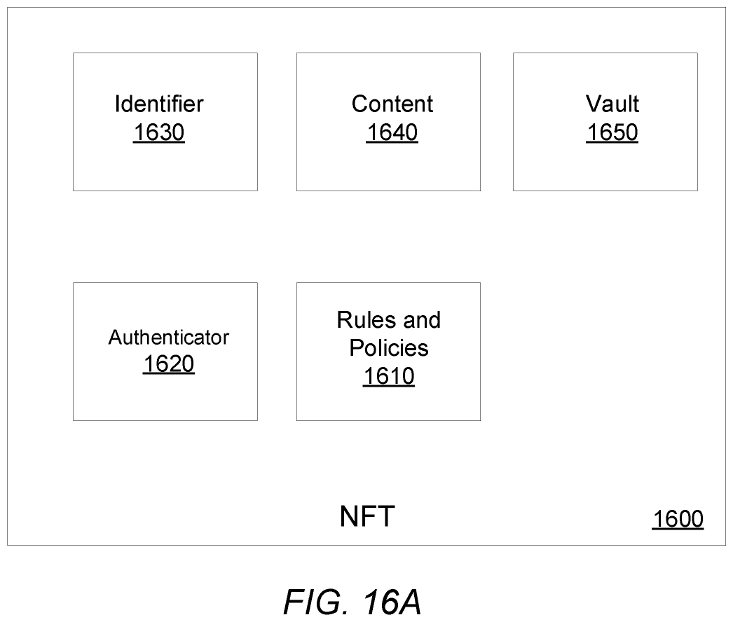

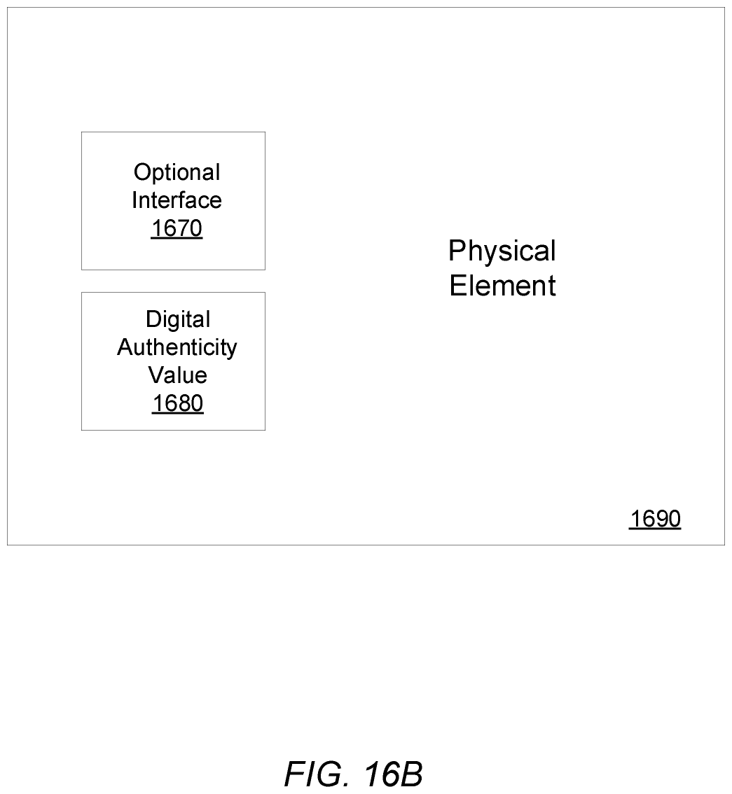

An example NFT which may be associated with specific content in accordance with several embodiments of the invention is illustrated in FIG. 16. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

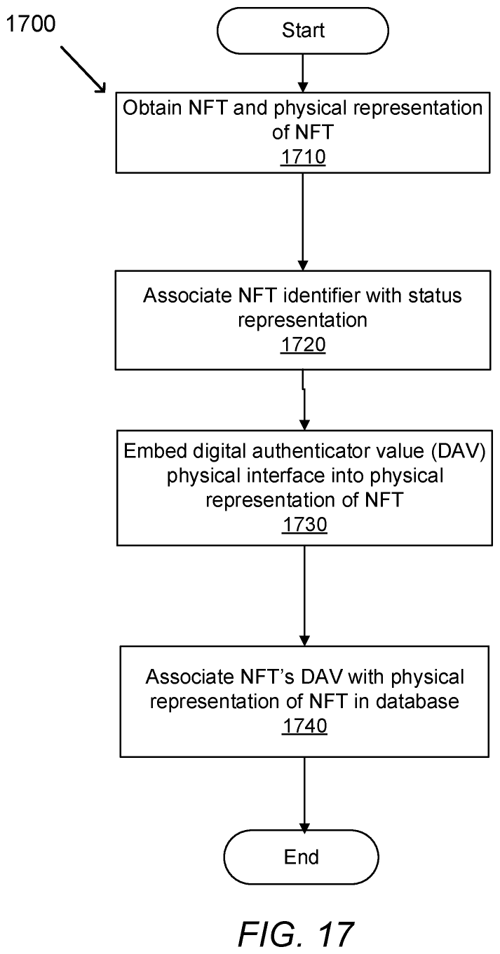

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

### State Capture Process

Although many of the examples described herein refer to gaming environments, one skilled in the art will recognize that similar systems and methods can be used in a variety of applications, including (but not limited to) conference call environments, augmented reality situations, entertainment virtual environments, as well as other virtual and augmented reality environments, without departing from this invention. Examples of applications to virtual and augmented reality environments are disclosed in co-pending applications U.S. Provisional Patent Application No. 63/219,864 filed Jul. 9, 2021 titled “Using Tokens in Augmented and Virtual Environments” and U.S. patent application Ser. No. 17/811,831 filed Jul. 11, 2022 titled “Systems and Methods for Token Management in Augmented and Virtual Environments” which are hereby incorporated by reference.

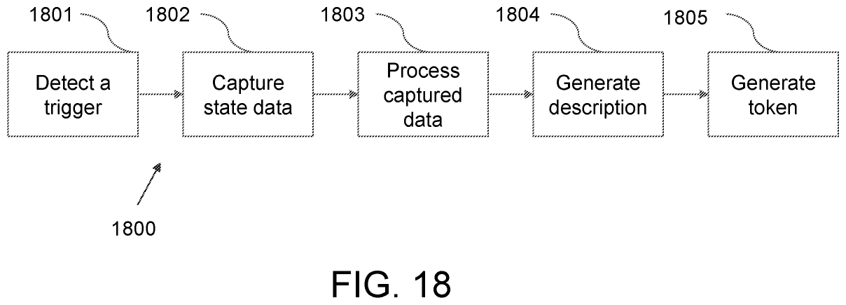

In various embodiments, processes can generate tokens. Tokens can represent captured state data. An example state capture and token generation process is conceptually illustrated in FIG. 18. A state capture process can be a process for capturing state data associated with a game environment. A token generation process can be the generation of a token representing the captured state data. The process 1800 can detect (1801) a trigger. In many embodiments, the trigger can be an in-game achievement (e.g., the advancement to a new level or the acquisition of a new skill by a character). The process 1800 can capture (1802) state data. In several embodiments, state data can be captured using an API (e.g., an entity external to the game can use an API to capture state data). In some embodiments, state data capture can be performed in the game (e.g., by selection of one or more data items). The process 1800 can process (1803) captured data. In some embodiments, processing captured data can include augmentation of the data, (e.g., by associating ownership data), change of a format of the captured data, and/or the removal of sensitive and/or irrelevant information from the data. The process 1800 can generate (1804) one or more descriptions. In a number of embodiments, generating one or more descriptions can include selecting qualitative labels from a list, can be based on in-app (e.g., in-game) configurations or achievements, and/or can include generating and/or curating quantitative descriptions (e.g., specifying the strength, wealth, wellbeing or stamina of a character). In some embodiments, generated tokens (e.g., NFTs) can be badges. In accordance with several embodiments of the invention, a badge icon can be another form of descriptions (e.g., representation) of the captured data. In some embodiments, icons can be selected and/or modified based on classifications of captured data (e.g., indicating that an achievement has been reached by selecting an image associated with the achievement). The process 1800 can generate (1805) a token based on the captured data. Generating a token can include interaction with a server that generates a token representation from the processed data, the generated descriptions and/or player data. Token generation can also be performed by processes in the game. For example, Alice is awarded an in-game badge when she accomplishes each of four major milestones within the game. The badge can be expressed as a token that is spawned based upon a trigger and associated change in state data of the token or an associated token. Alice, having proudly accomplished the first three milestones is also able to display the awarded badge on her social media account. In several embodiments, tokens (e.g., badges) can be interoperable between different processes (e.g., platforms, and/or applications).

In some embodiments, captured state data can include a recording of a teleconference, a game state, an application state, and/or other content. In several embodiments, tokens can be used to facilitate access control to the state data. The state capture data may correspond to a portion of the repair history of an appliance or auto, with the associated token comprising references to multiple such portions of repair history. State capture data associated with an initial state may comprise an identifier, such as a factory-assigned serial number, a vehicle identification number (VIN) or a Bluetooth Device Address; such data corresponds to the state of the physical item at the time of manufacturing. State capture data may also comprise information about components of the final product, and the provenance of such components.

In accordance with embodiments of the invention, state capture processes can extract aspects of applications (e.g., games) and store those extracted aspects as tokens. Aspects can be content. In some embodiments, in a game, there can be multiple characters. Each of the characters can acquire a state. The state can describe the characteristics of the character (e.g., their possessions, capabilities, beliefs, and experiences). In several embodiments, captured states can correspond to the state of one such character, and/or the state of a collection of such characters. Captured states can correspond to the states of items (e.g., a damaged sword or unloaded weapon). The captured states may relate to digital artifacts, physical objects, or combinations of such.

In several embodiments, automated annotation processes can associate captured states with one or more qualitative descriptions (e.g., a textual description of an achievement and/or situation). In some embodiments, the captured state can be associated with one or more quantitative descriptions (e.g., such as a score indicating a strength, experience, or a success likelihood) associated with a captured state. In accordance with several embodiments of the invention, annotations can be associated with tokens and can be viewed by parties rendering portions of tokens. The annotations can be part of the token, be external from the token, can be referenced from the token, and/or can be part of a derived token that references the token with the captured state. Throughout this document, annotations can be (but need not be) part of the token. In several embodiments, tokens can interact with other tokens to determine the other tokens' annotations. Processes for combining and recombining tokens to generate new and different tokens are disclosed in U.S. Provisional Patent Application No. 63/248,570 filed Sep. 27, 2021 titled “Content Evolution Techniques” and U.S. patent application Ser. No. 17/929,894 filed Sep. 6, 2022 titled “Methods for Evolution of Tokenized Artwork, Content Evolution Techniques, Non-Fungible Token Peeling, User-Specific Evolution Spawning and Peeling, and Graphical User Interface for Complex Token Development and Simulation” which are hereby incorporated by reference. In various embodiments, interactions (e.g., interactions between tokens) can be based upon locations. An example is when two different characters in a virtual gaming environment approach each other in the environment. In several embodiments, interactions can be based upon time, character discussion, and/or many other possible triggers.

In several embodiments, tokens can be ranked based on their quantitative descriptions. Quantitative descriptions can include a traditional high score list ranking player names with respect to their scores. In various embodiments, qualitative descriptions can be arrays including multiple dimensions. In many embodiments, ranking can be performed with respect to one or more dimensions. One way in which to rank with respect to multiple dimensions can be to generate a mapping. Rankings can be generated from an array to a value using a mapping. A mapping can be a weighted sum. Rankings can be performed with respect to values generated from mappings.

In many embodiments, tokens can also be sorted with respect to qualitative descriptions. Tokens can be clustered with respect to the presence or absence of selected criteria. Selected criteria can include personality traits, being described as being suspicious, and/or the possession of any element (e.g., a mode of transportation, a food item, a clothing item, and/or any other element).

In several embodiments, tokens include containers with different access privileges. In accordance with various embodiments of the invention, tokens can have 1, 2, 3, 4, or another number of containers. A token can have three containers. In many embodiments, containers can include annotations and other descriptive elements. An example descriptive element can include an image representing a state that was captured. A second example container can include and/or reference the captured state as it is accessible to the player that achieved the state. The player that achieved the state can be the token owner. A third example container can include and/or reference the state as a third party conditionally accesses the state. In some embodiments, containers can provide access to content. Access rights to content can be granted by the token owner. In accordance with several embodiments of the invention, access can be time-limited, can be conditional on a payment, can be conditional on the owner receiving some access rights in return, etc. In a number of embodiments, access rights for different containers can be governed by one or more access policies contained in a policy element of the token. In several embodiments policies can be selected or configured by the token owner, by a token originator (e.g., a game producer, and/or an artist); and yet others. In various embodiments, policies can be pre-configured and not possible to modify.

In some embodiments, token content can include one or more elements. Elements can include audio data, visual data such as images and movies, executable content, and/or a combination of such formats. In several embodiments, state capture can result in the generation or modification of a token. Modification of a token can include changes in content access rights. In certain embodiments, state captures can be triggered by user requests, user actions, in-game achievements, temporal determinations (e.g., when a timer indicates that users have played the game for a threshold amount of time). In some embodiments, state changes can also include changes in state determined by off-chain information being incorporated by means of an oracle, a bounty hunter, etc. An example oracle may comprise one or more entities that select an input based on a consensus mechanism. In accordance with various embodiments of the invention, state information can also be obtained from digital rights management (DRM) modules, trusted execution environments (TEEs) and/or another trusted or semi-trusted components. In a number of embodiments, update requests can trigger state captures from an application managing tokens (e.g., a wallet). In accordance with embodiments of the invention, state capture can cause state data to be recorded and associated with at least one token. In several embodiments, the recording can include the extraction, from a game environment, of one or more values, files, attributes and/or level indicators. In various embodiments, the generation of assessments can be performed by game environments, and/or can be determined by an external entity with access to the recorded data.

In several embodiments, captured state data can be authenticated and encrypted before being incorporated and/or referenced in a token. In certain embodiments, authentication can include a digital signature and/or message authentication code (MAC) associated. Digital signatures and/or MACs can be associated with at least one of the execution environments of games and/or the game manufacturers. In various embodiments, digital signatures and/or MACs can be used to prevent manipulation of game state as it is being stored in content. In a number of embodiments, the use of encryption, which can be based on either symmetric or asymmetric cryptography processes, blocks extraction of data by unauthorized processes. In some embodiments, data can be associated with access rights. In certain embodiments, access rights can identify the game environments in which captured state data can be used. In accordance with various embodiments of the invention, access right indications can be modified (e.g., if a token including captured state data is sold by the player to another user, who wishes to incorporate the captured state data in his or her game play).

In some embodiments, tokens can correspond to states associated with a first application (e.g., game). Tokens can, when compatible with a second application (e.g., game), be used to instantiate a character or situation in the second application. In accordance with several embodiments of the invention, the second application can be a continuation of the first application, an application by the same manufacturer, and/or an application that enables at least some extent of compatibility with the first application. In various embodiments, compatibility can be unilateral or bilateral.

While specific processes for state capture and token generation are described above, any of a variety of processes can be utilized for state capture and token generation as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to state capture and token generation, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

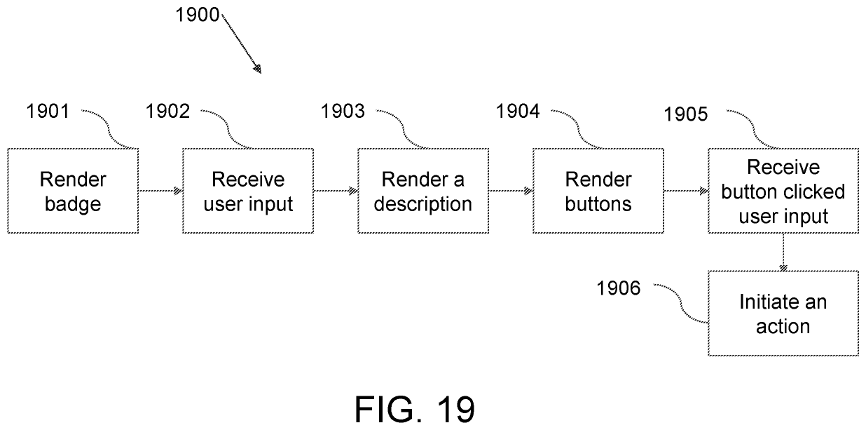

In various embodiments, users can interact with badges representing captured state data. Badges can be tokens. Badges can be tokens including state data. An example process for user interaction with a badge representing captured state data is conceptually illustrated in FIG. 19. The process 1900 can render (1901) a badge in an interface. In some embodiments, the interface can be a social media timeline. The process 1900 can receive (1902) a user input. In several embodiments, user inputs can include clicks. User inputs can be users clicking the badge, users hovering over the badge, and/or users otherwise interacting with the badge. The process 1900 can render (1903) a description associated with a token. In various embodiments the token is associated with the rendered badge. In several embodiments, rendered descriptions can include elements from quantitative or qualitative descriptions. In many embodiments, rendered descriptions can be selected and/or generated based on quantitative and/or qualitative descriptions. The process 1900 can render (1904) one or more buttons. In some embodiments each rendered button corresponds to an allowed user action. Allowed user actions can be associated with token. Determinations of what is allowed can be determined based on one or more policies associated with the token. Determinations of what is allowed can include determinations of access rights to content. The process 1900 can receive (1905) a button clicked user input. The process 1900 can initiate (1906) an action related to a token based on the button clicked user input. In several embodiments, actions can include to render a segment representing game play and/or the making of a bid for an aspect associated with the token (e.g., such as a digital sword owned by a character corresponding to the token).

In various embodiments, token data can be represented as badges on a user's social media accounts and/or game profiles. In many embodiments, badges can represent characters having reached a character state. In accordance with numerous embodiments of the invention, a character state can be a strength level and/or other characteristic level. Character states can be represented using visual icons. In some embodiments, visual icons can include images, movies, and/or renderings of visual content. In several embodiments, renderings of visual content can be based on the context with which it is being rendered (e.g., enable coloring or clustering of icons based on the assessed degree of achievement, which can be relative to other icons being displayed). In many embodiments, users can interact with badges by clicking on or hovering over them. In several embodiments, hovering over badges can provide users with additional information about the recorded state, (e.g., the quantifying and qualifying data associated with the token related to the displayed badge). In some embodiments, users can click on buttons to request borrowing, leasing and/or purchasing tokens. In several embodiments, token owners can grant requests to borrow, lease and/or purchase tokens. When requests are granted (e.g., by the owner) can be determined automatically based on rules, prices and/or by interactions with owners. In several embodiments, users can be granted additional access to the token and its contents based on requests. In accordance with various embodiments of the invention, depending on the type of access rights granted, token access rights can confer users access within an application. Within application access can be based on states associated with the token of which the badge is a visual representation. In many embodiments, access rights can include the ability to watch a pre-recorded segment of the token owner's game. The pre-recorded segment can be of relevance to the achievement reflected by the token. In various embodiments, the token can enable users to play a portion of the game associated with the achievement and/or the pre-recorded segment. The token can enable users to re-live (e.g., re-game, re-play) a particular segment of the game-play that resulted in the token, and/or to share the portion of the game in the form of a game highlight token. In many embodiments, tokens can also enable users (e.g., if purchasing the token), to incorporate the token in the users' own games (e.g., by acquiring the same context as reflected by the token). In accordance with embodiments of the invention, incorporating tokens in users' games can correspond to a game state change. The state change can correspond to acquiring a personality trait, an ownership of a talent object, and/or other facets of the game.

While specific processes for user interaction with a badge representing captured state data are described above, any of a variety of processes can be utilized to enable user interaction with a badge representing captured state data as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to user interaction with a badge representing captured state data, the techniques disclosed herein may be used in any type cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

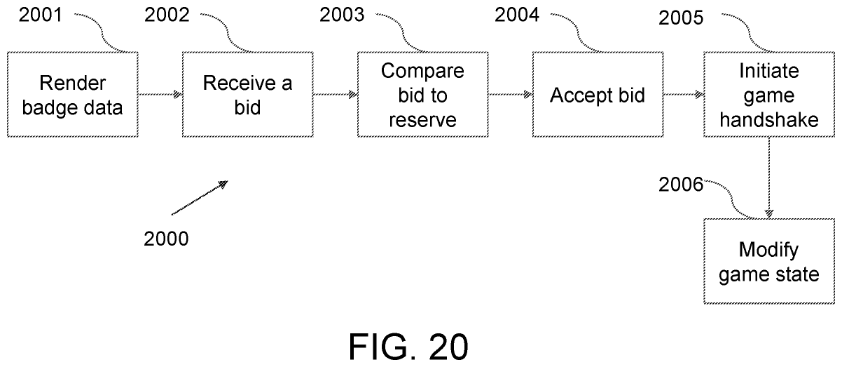

In many embodiments, tokens can be transferred based on bids. An example process for a transfer of ownership of a token in response to a bid is conceptually illustrated in FIG. 20. In many embodiments, tokens can represent captured state data. In some embodiments, a transfer of ownership of a token can include the removal of associated state data from the game environment from which the state data was captured. The process 2000 can render (2001) badge data. In various embodiments, rendering badge data can include rendering the badge in an interface of an application (e.g., a social media application, a browser, and/or a wallet application). The process 2000 can receive (2002) a bid. In several embodiments, the bid is received in response to a button being clicked. The button can be associated with a purchase. In various embodiments, the potential buyer can specify a bid and/or agree to a bid associated with a purchase button. The process 2000 can compare (2003) a bid to a reserve. The reserve can be a numeric value. The process can accept (2004) the bid. The process 2000 can initiate (2005) a handshake. In several embodiments the handshake can be between an environment associated with the token and a game server. In some embodiments, the handshake can indicate the token and/or an identifier associated with the token. In several embodiments, the handshake can indicate a recipient of rights. In many embodiments, the recipient of rights can correspond to a buyer and/or a party leasing the rights associated with the token. In many embodiments, game servers can verify that rights can be transferred and/or can determine whether the transfer of the rights requires the removal of rights associated with the seller of the token. The process 2000 can modify (2006) the game state of one or more users based on the rights granted in the handshake. In many embodiments, the user who is the buyer of a token can be granted access rights or capabilities in the context of the game. In some embodiments, a user who is the seller of the token can have his or her access rights or capabilities modified (e.g., restricted to exclude a feature being transferred to the buyer). In some embodiments, the granting and restriction of the rights can be temporal (e.g., only lasting for 48 hours), which can correspond to a loan or a lease of capabilities indicated by the token. In several embodiments, the granting and restriction of rights can be permanent (e.g., remain in effect until subsumed by another transfer action).

While specific processes for a transfer of ownership of a token in response to a bid are described above, any of a variety of processes can be utilized to transfer of ownership of a token in response to a bid as appropriate to the requirements of specific applications. In certain embodiments, steps may be executed or performed in any order or sequence not limited to the order and sequence shown and described. In accordance with numerous embodiments of the invention, some of the above steps may be executed or performed substantially simultaneously where appropriate or in parallel to reduce latency and processing times. In some embodiments, one or more of the above steps may be omitted. Although the above embodiments of the invention are described in reference to a transfer of ownership of a token in response to a bid, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

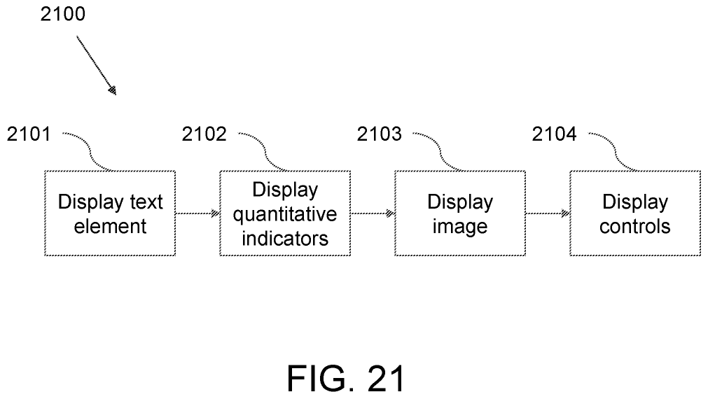

In a number of embodiments, qualitative and quantitative data associated with a captured state can be rendered in applications (e.g., in the context of a social network account). An example process for rendering of qualitative and quantitative data associated with a captured state is conceptually illustrated in FIG. 21. The process 2100 can display (2101) a text element associated with captured state data. An example of such a text element is “won 10 consecutive matches”, another is “just married”. The process 2100 can display (2102) a qualitative indicator. An example qualitative indicator is a character's stamina or gold possessions. Qualitative indicators can be indicated by a meter, a representation of funds, or by an image that is indicative of a strength (e.g., such as a worm, a cat, or a bull). The process 2100 can display (2103) an image representing a token. Examples of images representing tokens can include screen shots, recordings, and/or representations of significant game achievements. The process 2100 can display (2104) one or more controls. Example controls include buttons, slide bars, and indicators of the presence of hover-over actions available.

While specific processes for rendering of qualitative and quantitative data associated with a captured state are described above, any of a variety of processes can be utilized to render qualitative and quantitative data associated with a captured state] as appropriate to the requirements of specific applications. In certain embodiments, steps may be executed or performed in any order or sequence not limited to the order and sequence shown and described. In accordance with numerous embodiments of the invention, some of the above steps may be executed or performed substantially simultaneously where appropriate or in parallel to reduce latency and processing times. In some embodiments, one or more of the above steps may be omitted. Although the above embodiments of the invention are described in reference to rendering of qualitative and quantitative data associated with a captured state, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

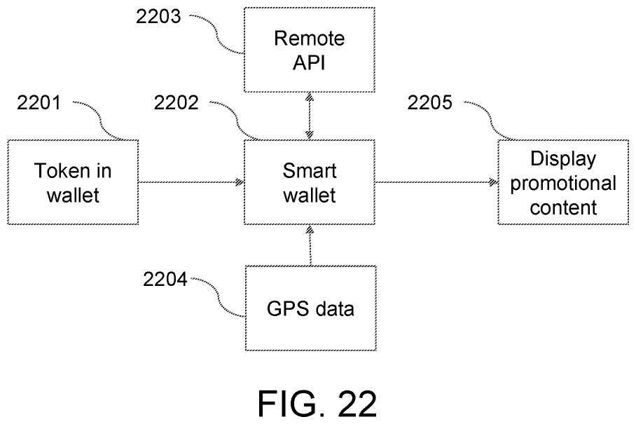

In many embodiments, promotional content can be displayed based on a smart wallet, location data (e.g., GPS data), and/or data retrieved through APIs. An example system for displaying promotional content based upon one or more tokens, a smart wallet on a smart device, location awareness, and/or APIs capable of retrieving information is conceptually illustrated in FIG. 22. A token 2201 can exist in a smartphone wallet that represents a token licensee's interest (e.g., a shopping loyalty program token). The smart wallet 2202 can be capable of monitoring policies associated with the token 2201. The smart wallet can receive GPS location data 2204. In accordance with various embodiments of the invention, GPS data can be received from a smart device. The smart wallet 2202 can be configured to monitor wallet and/or token policies that enable the smart wallet 2202 to interact with a remote API 2203. The smart wallet 2202 can display promotional content 2205 when a user with the specific token is in a particular location (e.g., such as in-store with a smart device and a smart wallet containing an appropriate token).

In several embodiments, access to tokens (e.g., tokens including captured state data) can inform an advertisement targeting unit associated with a display unit. The advertisement targeting unit can base advertisement selections on the interests of a user, and/or can enable the selection of related content and advertisements for the user. Basing displayed content on tokens and users is disclosed in co-pending applications U.S. Provisional Patent Application No. 63/210,040 filed Jun. 13, 2021 titled “Content Recommendation Process”, U.S. patent application Ser. No. 17/806,728 filed Jun. 13, 2022 titled “Systems and Methods for Encrypting and Controlling Access to Encrypted Data Based Upon Immutable Ledgers”, U.S. Provisional Patent Application No. 63/223,099 filed Jul. 19, 2021 titled “Advertisement Portability Methods”, and U.S. patent application Ser. No. 17/811,831 filed Jul. 11, 2022 titled “Systems and Methods for Token Management in Augmented and Virtual Environments” which are hereby incorporated by reference. In some embodiments, game manufacturers can determine the extent of interest among users who have not yet purchased the game. Extent of interest can be determined by determining demographic data and user-unique data to assess likely popularity of the game and use such insights to select promotion strategies.

In several embodiments, user-unique data can include a rolling pseudonym that is the same during a limited period of time and then changes in a way that prevents tracking. This is a form of pseudonymous user-unique data, and it can be used to determine when one user is interested in multiple different games. In certain embodiments, other identifiers can also be used. In various embodiments, user display units can include and/or interact with privacy enhancing units. Privacy enhancing units can determine what data to report to a game creator and/or intermediary associated with the game creator. In a number of embodiments, selected data for reporting can be determined, based on a user's privacy settings. In certain embodiments, when a user has not yet set any privacy settings, the user can be required to select privacy settings prior to being enabled to access content. (e.g., by viewing a recording of an in-game achievement). In many embodiments, users exhibiting interest in a given game by viewing recorded portions of another user's experiences can be provided with coupons to purchase games.

In accordance with numerous embodiments of the invention, tokens can be associated with access policies. Access policies can identify which entities can access different token containers and/or under what conditions. In accordance with embodiments of the invention, access policies can identify entities by a public key. Public keys can correspond to entities that are allowed to access data, and/or to entities that are allowed to delegate access permissions. In some embodiments, access policies can identify permitted users by their role without identifying other user credentials. In some embodiments, roles can include “owner of the token” or “leasee of the token.” In certain embodiments, separate records can be used to determine whether given users are associated with roles that have been identified in policies. An example token type is an NFT. Tokens can include tokens with executable content, derived tokens, and/or other token types. Suitable token types that can be used are disclosed in co-pending application titled U.S. Provisional Patent Application No. 63/213,251 filed Jun. 22, 2021 titled “Token Creation and Management Structure” and U.S. patent application Ser. No. 17/808,264 filed Jun. 22, 2022 titled “Systems and Methods for Token Creation and Management,” which are hereby incorporated by reference. In many embodiments, content containers of tokens can include and/or reference data that in itself are tokens.

In many embodiments, there can be numerous types of triggers for tokens to become active or interactive with one another. In some embodiments, tokens can be loosely associated based upon distance from one wallet to another wallet. In several embodiments, distance can be based on real world distances (e.g., when two or more patrons are in the same pub with mobile devices), and/or on virtual world distances when two or more tokens or wallets are virtually near one another (e.g., such as when two gamers enter the same virtual room). In various embodiments, token activities can be triggered by times, events, and/or maturities. Token triggering awareness can be inherent in the smart contract policies, such as when an oracle provides the final score of an important football match. In some embodiments, a smart contract policy can identify similar fan tokens local to the token owner.

In accordance with embodiments of the invention, smart token wallets can monitor activity triggers. In some embodiments, wallets can be configured to monitor token policies and activate changes. Changes can include the combining of two tokens based upon inputs. Inputs can be received from other wallets, sensors (e.g., GPS and microphone sensors in smartphones), and/or Bluetooth™ beacons (e.g., as one can encounter in a retail environment). In several embodiments, wallets can perform token storage and can also be configured to add and/or adjust data and/or metadata. Metadata can include data associated with a token, but not contained within the token and/or its asset. In various embodiments, smart token wallets can be associated with policies identifying what entities can access different token containers and/or smart wallets. Policies can specify under what conditions access is granted. Access policies can identify entities based on public keys. In a number of embodiments, public keys can correspond to entities that are allowed to access data, and/or to entities that are allowed to delegate access permissions. In accordance with embodiments of the invention, access policies can identify permitted users by their role. Roles can include “owner of the token or wallet.” In some embodiments, access policies can identify permitted users by their role without identifying which users have such rights. In several embodiments, separate records can be used to determine whether a given user is associated with a role that has been identified in a policy.

In certain embodiments, tokens can be configured by policies, and/or within parameters and/or settings of a smart wallet. In a number of embodiments, tokens can receive information about their surroundings. In accordance with embodiments of the invention, tokens residing in wallets can represent a token licensee's membership (e.g., membership in a warehouse shopping club). Token and wallet combinations can be capable of detecting wallet locations, and/or locations of devices accessing wallets. An example is a smartphone with a GPS that is presently reporting that it is within the real estate of a local warehouse shopping center. With such knowledge, a token policy and/or a smart wallet can be configured to interact with the club's coupon generation API which can issue a free promotional coupon (e.g., for a 48-roll toilet paper package). In many embodiments, interaction with APIs can be triggered by smart wallets and can be allowed by policies of the tokens and/or the smart wallet settings.

In some embodiments, smart wallets can be configured to interact with users' smartphone browsing and/or search histories. For example, Bob is a big fan of his local professional baseball team. Bob has a token in his wallet related to his interest in the team. Bob's search history reveals that he is looking at airfares from his hometown to Cleveland. The wallet, containing his fanatic team token, recognizes through an API that his favorite baseball team is scheduled to be in Cleveland during his travel time window, and offers him low-cost seats to one of the games.

While specific systems for displaying promotional content based upon one or more tokens, a smart wallet on a smart device, location awareness, and/or APIs capable of retrieving information are described above, any of a variety of system can be utilized to display promotional content based upon one or more tokens, a smart wallet on a smart device, location awareness, and/or APIs capable of retrieving information as appropriate to the requirements of specific applications. In certain embodiments, components can be included in any arrangement or sequence not limited to the arrangement and sequence shown and described. In accordance with numerous embodiments of the invention, some of the above components may be execute or performed substantially simultaneously where appropriate or in parallel to reduce latency and processing times. In some embodiments, one or more of the above components may be omitted. Although the above embodiments of the invention are described in reference to displaying promotional content based upon one or more tokens, a smart wallet on a smart device, location awareness, and/or APIs capable of retrieving information, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

### Token Validity Assessment

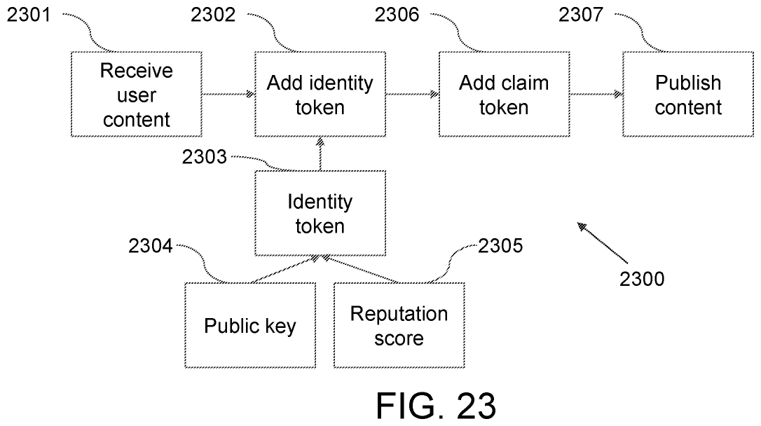

In some embodiments, content produces can publish content that includes an identity token. An example process for applying tokens to items is conceptually illustrated in FIG. 23. The process 2300 can receive (2301) user content (e.g., a manuscript, an image, a video) from a publishing user. The process can add (2302) an identity token 2303 (e.g., to the content) as evidence of the publishing user's real identity. In some embodiments, an optional alias token, not shown, may be utilized for journalists with a pen name. The identity token 2303 can be based on a public key 2304 and can include a reputation score 2305. In several embodiments, public keys and/or reputations can be associated with publishing users. The process 2300 can add (2306) a claim token to the content. The process 2300 can publish (2307) the content with one or both tokens included. As described elsewhere herein above, the application of the tokens may be automatic, such as by publishing software.

In some embodiments, originators can be associated with items (e.g., content). In accordance with various embodiments of the invention, items can include news briefs. In certain embodiments, processes can generate tokens. Generated tokens can include non-fungible tokens (NFTs) based the originator identities and items. In many embodiments, expressions of originator identities can include (but are not limited to) public keys, user names, email addresses, phone numbers, unique application identifiers, identity tokens, alias tokens, and/or combinations of such values. In some embodiments, originator identity and/or parts thereof can be encrypted in order not to expose personally identifiable information to non-authorized parties. Examples of items include (but are not limited to) texts such as news items or assertions; references to other users, where such references may include identifiers or encrypted identifiers; images; videos; audio; and commentary on other tokens, and/or a combination of such data.

In accordance with embodiments of the invention, processes can associate, with a token (e.g., a token described elsewhere herein), one or more claims. In some embodiments, claims can indicate an opinion related to the token with which the claims are associated. In some embodiments, an opinion can be tied to at least one of reputation values and/or financial quantities. In several embodiments, reputation values can include one or more scores indicating past performance. Past performance can be evaluated in terms of identifying valid and/or invalid content. Past performance can be determined relative to a final determination of validity and to the claim made by the user associated with the reputation value. In several embodiments, every time a user makes a claim that is later found to correspond to a correct assessment, the reputation score of the user can incremented by a value. In a number of embodiments, values can depend on whether the associated user claim was the first claim made, the first positive claim, the first negative claim, and/or using other qualifiers. In many embodiments, financial quantities can correspond to escrowed funds, to conditional payment that may be expressed using a smart contract, and/or to promissory notes. Promissory notes can include cryptopayments linked to conditions governing how the cryptopayments are released. In certain embodiments, claims can include one or more weights. Weights are described in more detail elsewhere herein. Tokens that are associated with one or more claims, or have the capability to become associated with one or more claims, can be called claim tokens.

In various embodiments, entities (e.g., social networks, search engines) can facilitate the display of content, of the kind disclosed herein. In several embodiments, entities can compute one or more quality scores based on claims and/or claim tokens. In several embodiments, certainty scores can be determined based on the or more quality scores. The certainty scores can be based on statistical significance of one or more quality scores. The statistical significance can be computed using statistical methods. In various embodiments, users can configure applications used for display of content. Content can be associated with social media profiles. Content can include references to one or more threshold values (e.g., configuration parameters). Threshold values can indicate how content of a token with a given quality score and/or certainty score can be treated. Treatments can be selected based on a comparison between threshold values (e.g., configuration parameters) and values (e.g., quality score, certainty score, reputation and/or other values) associated with the content. Association with the content can include references to tokens. Treatments can include blocking, placing on a timeline, entered into an inbox, be made available for searches by the user, filtered, etc. In various embodiments, entities can associate threshold values with users based on the users' identification information (e.g., indicators, such as an IP address, indicating a geographical location). Users in one location may be associated with one jurisdiction and therefore be subject to a first threshold and users in another jurisdiction can be subject to a second threshold. In several embodiments, first users of a first kind can be subject to one threshold, and second users of a second kind can be subject to a second threshold. In accordance with various embodiments of the invention, adults can be associated with one threshold, teenagers a second threshold, and pre-teens with a third threshold. In several embodiments, any number of sets of threshold values can be associated with a number of user categories. Categories can be defined based on characteristics of the users.

In many embodiments, users can be required to automatically commit at least a minimum quantity of funds or reputation points, such as $0.01 or 0.4 reputation points to perform an action. Actions can include retweeting of a message from a stranger to a group, retweeting of a message from to a group including more than a threshold (e.g., 50) number of recipients, and/or any other condition. In many embodiments, claims can be determined based on a type. In several embodiments, types can be received based on user indications. Indications can be received in connection with users initiating the sharing of tokens. In various embodiments, sharing a token can include sharing a token's associated content. In a number of embodiments, separate types of reputation score can be used for generating claims and for taxing actions (e.g., retweets). Separate types of reputation score can be associated with one or more available budgets for the user. In accordance with embodiments of the invention, users can exchange financial funds and reputation points on exchanges.

While specific processes for applying tokens to items are described above, any of a variety of processes can be utilized to apply tokens to items as appropriate to the requirements of specific applications. In certain embodiments, steps may be executed or performed in any order or sequence not limited to the order and sequence shown and described. In accordance with numerous embodiments of the invention, some of the above steps may be executed or performed substantially simultaneously where appropriate or in parallel to reduce latency and processing times. In some embodiments, one or more of the above steps may be omitted. Although the above embodiments of the invention are described in reference to applying tokens to items, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

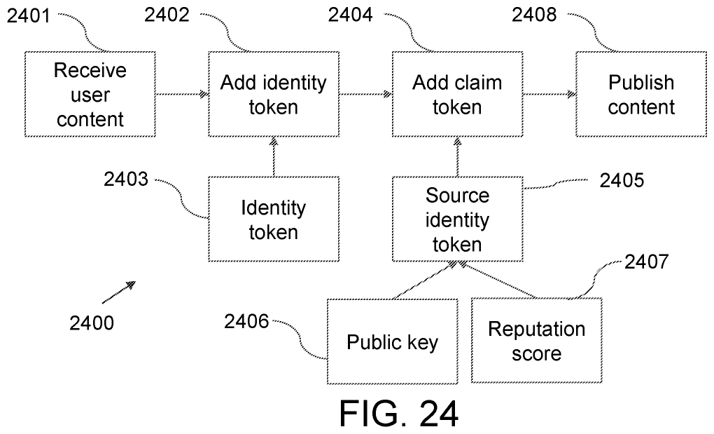

In various embodiments, claim tokens can be based on source identity tokens. In a number of embodiments, source identity tokens can be associated with a public key and a reputation score. An example process for applying claim tokens to items is conceptually illustrated in FIG. 24. The process 2400 can receive (2401) user content (e.g., a manuscript, an image, a video) from a publishing user. The process can add (2402) an identity token 2403 (e.g., to the content). The identity token can be evidence of the publishing user's real identity. The process 2400 can add (2404) a claim token to the content. The claim token can be based on a source identity token 2405. The source identity token can include a public key 2406 and/or a reputation score 2407. The process 2400 can publish (2408) the content with one or both tokens included. As described elsewhere herein above, the application of the tokens may be automatic, such as by publishing software. In various embodiments, the source identity token can be an alias. In some embodiments, when the content is published it can include and/or reference the identity token (e.g., an identity token associated with the content generator) and/or claim token.

In some embodiments, users can make a claim by using an interface in which he selects one or more claim types. Claim types can include (but are not limited to) “false statement”, “truthful statement”, “unsupported statement”, “supported statement”, “unreliable source”, “reliable source”, “not insightful”, “insightful”, “not funny”, “funny”, “not offensive”, “offensive”, “contains nudity”, “does not contain nudity”. In several embodiments, the claim encodes one or more identifiers encoding such user-selected types. In certain embodiments, when users make claims, the users can select weight values to associate with claims. The weight value can be a pre-set value. The weight value can be based on past claims, user-set preferences, and/or can be a user-input value. In accordance with various embodiments of the invention, weights can correspond to references. In some embodiments, references can be in the form of 3rd-party tokens and their respective weights that help back the claim. In many embodiments, weights can correspond to amounts of funds that a user associates with a claim, an amount of reputation the user associates with a claim, and/or a combination of these. Claims can include the reputation of a claimant's employer. In several embodiments, claims can include one or more references. Supporting references can be references supporting the view of the user making the claim. In various embodiments, users can use GUIs to identify times during videos that there is nudity, and/or mark up an image to show where there is nudity. In many embodiments, users can also support statements that images have been doctored (e.g., by combining two or more component images) by providing references to the one or more reference images. In various embodiments, users can support that a text contains falsehoods by identifying the portions of the text that are contested and associating a reference that supports that these are not true. In many embodiments, claims can include reputation values for alias identities with, or without a known history of quality. For example, such as when a government insider shares information with consistent quality, that insider may have an alias token that shields the insider from their linked identity token.

In certain embodiments, a first token (e.g., a pseudonym token) can reference a second token (e.g., an identity token). In various embodiments, the second token can be not accessible to the public and/or can be encrypted (at least in part). Hence, a pseudonym token may refer to a token in which an identity is stored. In many embodiments, the identity can be stored in an encrypted manner. Observers may lack the decryption key, but observers can tell that the pseudonym token corresponds to *some* identity. In some embodiments, observers can check that an authority has agreed (e.g., by digitally signing the encrypted data, stating that the identity has been verified) that a pseudonym token is associated with an identity token. In some embodiments, authorities can use a decryption key in order to decrypt the data and obtain a decrypted identity associated with a pseudonym token. In some embodiments, decryption keys can be distributively stored so many entities need to collaborate to obtain decryption keys. In a number of embodiments, processes can determine whether an encrypted identity matches that of a given suspect, without revealing any other fact that “yes” or “no” (e.g., using zero-knowledge proofs).

In a number of embodiments, claims can be generated by agents. Agents can include software elements used to scan content. Classifications can be performed automatically based on content scans. Based on classifications, processes can determine one or more claim types and one or more weight values associated with the claim.

In accordance with embodiments of the invention, weights expressed in claims can be limited by available reputation scores and/or funding sources. In several embodiments, available scores and/or funding resources can only be allocated to supporting one claim at a time. For example, in some embodiments, when a user has a reputation score of 400 points, but has already associated 350 points of the reputation with other claims, only 50 points remain to be committed in a claim. In some embodiments, a user with a wallet including funds corresponding to an amount of 3 BTC or $300, where the user has already committed 2 BTC or $200 to other claims would have 1 BTC or $100 that can be used for commitment to another claim. The same applies to agents generating claims. A token may be associated with zero or more claims.

In many embodiments, when a user relates (e.g. allocates) reputation and/or funds to a claim, these are committed for a duration of time that may be specified by the claim. In accordance with numerous embodiments of the invention, a user may commit (e.g., allocate) funds and/or reputation forever, for a day, or until the funds and/or reputation points are reallocated by the user. In some embodiments, reallocation by a user, can be to a second claim, at which time the allocation to the first claim can be withdrawn. In several embodiments, funds and/or reputation may be rescinded if the claim is determined to be incorrect according to an authority. In various embodiments, users can receive an early refund of funds or reputation points, potentially with a reward of additional funds or reputation points based on an outcome. The outcome can be a determination of the validity of the user's claim in favor of the user.

In some embodiments, claims may be associated with values indicating return on investment. In several embodiments, return on investment can be measured in relation to funds and/or reputation points. In accordance with various embodiments of the invention, return on investment is measured based on the claim being found valid by an authority. In several embodiments, the determination of the return on investment (ROI) value, can be determined using similar techniques as those used by software used by bookies in horse races. ROI values can be determined based on the number of other claims, their associated types, their associated weights, and/or potentially any histories of correctness or incorrectness associated with the users or agents making the claims. In several embodiments, an ROI value of a number (e.g., 1, 2, 3 or another number) may indicate that, if found to be correct, the user is given a refund corresponding to the number (e.g., 3) times the amount of funds and/or reputation points associated with a claim the user makes.

While specific processes for applying claim tokens to items are described above, any of a variety of processes can be utilized to apply claim tokens to items as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to applying claim tokens to items, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

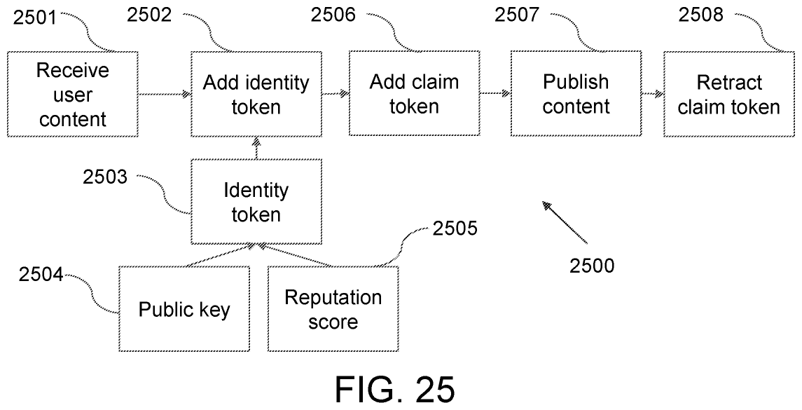

In several embodiments, process can retract claim tokens. An example process for retracting a claim token is conceptually illustrated in FIG. 25. The process 2500 can receive (2501) user content (e.g., a manuscript, an image, a video) from a publishing user. The process 2500 can add (2502) an identity token 2503 (e.g., to the content). The identity token can be evidence of the publishing user's real identity. The identity token 2503 can include or reference public key 2504 and/or reputation score 2505. The process 2500 can add (2506) a claim token to the content. The process 2500 can publish (2407) the content with one or both tokens included. The process 2500 can retract (2508) the claim token. As described elsewhere herein above, the application of the tokens may be automatic, such as by publishing software. In various embodiments, the source identity token can be an alias. In some embodiments, when the content is published it can include and/or reference the identity token (e.g., an identity token associated with the content generator) and/or claim token. In various embodiments, a redacting process can edit the content to improve, correct, and/or remove the content and/or claim token. In many embodiments, claim tokens can become obsolete and require replacement and/or re-minting when associated content is changed.

In some embodiments, users can retract claims. In some embodiments, when a user makes a claim at a time when the odds indicate a first ROI and the odds increase to a second ROI at the time the user wishes to retract the claim, the user can be given a refund that exceeds the previously committed amount. In several embodiments, when the second ROI has fallen to less than the first ROI, the user can be given only a partial refund of the previously committed amount. In several embodiments, the amounts can be denominated in reputation scores and/or financial quantities. In various embodiments, when users retract claims, the odds of the claim being verified (e.g., evaluated as accurate by an authority) can be automatically recalculated by the system. In various embodiments, systems can recalculate odds in response to any claim being made, or to the posting of a token without any associated claims. In a number of embodiments, retraction of claims and/or associated tokens can be enabled by including or referencing the original content within the token as a token element, such that if the content is changed, the token should also be removed and replaced. In accordance with embodiments of the invention, when the token is not replaced to match the new content, a discrepancy between the token and the content is obvious and may be policed by bounty hunters incentivized to locate such abnormalities or abuses.

While specific processes for retracting a claim token are described above, any of a variety of processes can be utilized to retract a claim token as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to retracting a claim token, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

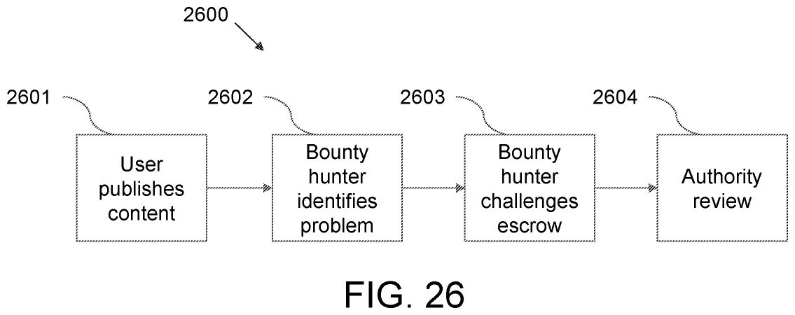

In some embodiments, authorities and/or bounty hunters can review published content for rewards. An example process for bounty hunters to review published content for rewards is conceptually illustrated in FIG. 26. The process 2600 can enable users to publish (2601) content. In accordance with numerous embodiments of the invention, the content can include one or more claim tokens. The process 2600 can enable a bounty hunter to identify (2602) a problem with the claim, the claim associated with the claim. In some embodiments, concerns about claims can include truthfulness, inappropriate classification, and others. The process 2600 can allow the bounty hunter to challenge (2603) the escrow of the respective claim. The process 2600 can allow an authority to perform (2604) a review to determine a suitable outcome.

In a number of embodiments, bounty hunters can challenge claims in a manner that also requires the bounty hunter to make counterclaims and provide financial backing. In accordance with embodiments of the invention, assessments of claims associated with a token can be performed by an authority. In some embodiments, an authority can be a government agency. In several embodiments, an authority can be an entity (e.g., as described elsewhere herein). In accordance with various embodiments of the invention, authorities can include mediators, news organization, political action groups and/or individuals. In several embodiments, authorities can be required to obtain the right to act as an authority. In some embodiments, authorities can possess tokens granting rights to act as an authority. In a number of embodiments, any given authority can be capable of only addressing claims of some types, and not others. In various embodiments, some claims, such as “funny” or “not funny” may not be addressed by any authority at all. In many embodiments, weights associated with claims that cannot be refuted by authorities can be set to zero. In some embodiments, claims of the types that can be assessed may require a non-zero quantity of financial and/or reputational backing.

While specific processes for bounty hunters to review published content for rewards are described above, any of a variety of processes can be utilized to enable bounty hunters to review published content for rewards as appropriate to the requirements of specific applications. In certain embodiments, steps may be executed or performed in any order or sequence not limited to the order and sequence shown and described. In accordance with numerous embodiments of the invention, some of the above steps may be executed or performed substantially simultaneously where appropriate or in parallel to reduce latency and processing times. In some embodiments, one or more of the above steps may be omitted. Although the above embodiments of the invention are described in reference to bounty hunters to review published content for rewards, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

Characteristic Assignment to Identities with Tokens

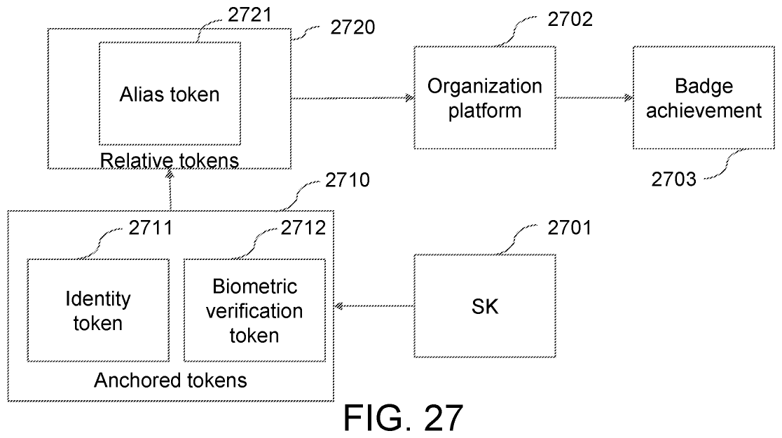

In several embodiments, achievements can be linked to users' identities. In some embodiments, recognition badges, or simply badges, can be tokens (e.g., NFTs). An example system for tying recognition badge achievements by an organization to a user's identity is conceptually illustrated in FIG. 27. A user's identity token 2711 and biometric verification token 2712 are anchored tokens 2710. The anchor tokens 2710 can be tied to a user's secret key 2701. An optional pseudonymous alias token 2721 can exist as a relative token 2720 to the anchored tokens 2710. The user, having registered their alias token 2721 and/or identity token 2711 with a 3rd-party organization platform 2702 can earn an achievement badge 2703. The achievement badge 2703 can be issued by the 3rd-party organization platform 2702 and/or other entities. The tokens described can be stored in the users' wallets.

In several embodiments, non-fungible tokens (NFT) can be minted which represent digital recognition badges. Recognition badges are also referred to as badges. NFTs can be referred to as tokens throughout this document. Tokens can include NFTs, and/or other types of tokens (e.g., fungible tokens). In certain embodiments, earned badges can be assigned manually and/or automatically. In various embodiments, processes for minting tokens can be executed on cryptographically secure decentralized public networks (e.g., Bitcoin and/or Ethereum blockchain networks, and/or on private blockchains). A private blockchain can include a private blockchain such as what an entity (e.g., a social media platform) might create in a controlled, centralized system. In many embodiments, a cryptographically secure decentralized public networks can be immutable, or semi-immutable. Examples of cryptographically secure decentralized public networks are disclosed in co-pending applications U.S. Provisional Patent Application No. 63/216,662 filed Jun. 30, 2021 titled “Pseudo-Immutable Blockchain Method” and U.S. patent application Ser. No. 17/810,085 filed Jun. 30, 2022 titled “Distributed Ledgers with Ledger Entries Containing Redactable Payloads,” which are hereby incorporated by reference. In a number of embodiments, badges can be minted as tokens. In accordance with embodiments of the invention, badges minted as tokens (e.g., on decentralized public blockchains), can be portable, combinable, redeemable, and/or tied to an individual's true identity. Tokens (e.g., badges) can be tied to an individual's true identity with the use of identity tokens and alias tokens. Examples of identity tokens and alias tokens as disclosed in co-pending application co-pending U.S. Provisional Patent Application No. 63/213,251 filed Jun. 22, 2021 titled “Token Creation and Management Structure” and U.S. patent application Ser. No. 17/808,264 filed Jun. 22, 2022 titled “Systems and Methods for Token Creation and Management,” which are hereby incorporated by reference. In some embodiments, badges awarded as tokens through a public blockchain can be considered licensed for use publicly by the awardee. In several embodiments, terms of use policies associated with a token can be controlled by a token's contract.

In some embodiments, recognition badges are tied to identifiers. In several embodiments, identifiers can be related to identities, and/or to pseudonyms. In certain embodiments, identities can include a person's name, social security number, email address and/or certified public key. In various embodiments, pseudonyms can be quantities that can be associated with identities, in a manner that is not publicly mappable. In some embodiments, pseudonyms can include limited-use public keys that are associated with identifiers. In some embodiments, associations between limited-use public keys and identifiers can be encrypted. In several embodiments, associations between limited-use public keys and identifiers cannot be determined (e.g., decrypted) without knowledge of a secret key, and/or without access to a proprietary database. In many embodiments, functionalities of recognition badges can depend on types of identifiers tied to it. In a number of embodiments, a token can perform a first action, when the token is tied to a pseudonym the token can perform a second action, and/or when the token is tied to a biometric-secured public key then the token can perform a third action. In accordance with embodiments of the invention, token functionalities can depend on the security of the identifier it is tied to. In some embodiments, a hand-shape biometric can be considered lower security than a fingerprint biometric, which can in turn can be considered lower security than an iris-based biometric. In several embodiments, security associated with identifiers can be pre-determined. In several embodiments, different functionality can be provided based on a security level of tied biometrics. In various embodiments, functionalities can depend on sources of certification of public keys (e.g., the rating of the certificate authority (CA), whether it is a root CA, whether the certificate was provided after a physical verification of identifiers, whether there is an assurance associated with the certificate, etc.) In some embodiments, functionalities can also depend on platform-based data (e.g., whether the badge is associated with a platform running on a trusted execution environment (TEE), on a platform with software-based attestation, and/or other platform-based data.

In several embodiments, recognition badges can be issued in response to users performing countable tasks (e.g., users performing their 100th purchase on a given platform); another badge can be issued in response to a person advancing past a threshold (e.g., to a particular level, such as 1, 2, 3, or another number, of a specified game). In several embodiments, recognition badges can be associated with quality values that indicate how rare the achievement is. For example, a badge that is offered to the 1% highest scorers is, by definition, only offered to 1 out of 100 users. A badge that is offered to any users having performed 100 purchases can, for example, have a quality value equivalent to a badge that is offered to between 10 and 15 out of 100 users. In certain embodiments, badges can correspond to maximum numbers of grants per 100 users, as per a policy associated with the badge. In accordance with various embodiments of the invention, badge quality values can be associated with ranges (e.g., between 10 and 20 per 100 users). In some embodiments, quality value ranges can be used to group different badges in a manner that organizes or ranks them in terms of exclusivity. In various embodiments, the arbitrary nature of many recognition systems can be avoided through automatization of the token minting and distribution process following software coded policies (e.g., of an organization).

In some embodiments, processes can be able to use the wallet associated with a user and/or multiple users, and analyze the smart contracts collected in the entirety of the wallets in order to award the badges. For example, an NFT marketplace platform announces that creators will get a “Top 10 November Creator” for the top artists that sell the most artwork on the system in the month of November. In some embodiments, the awarding of a badge can be accomplished by a process by analyzing all the smart contracts created on the platform during the month of November. In several embodiments, a badge called the “1 Million Dollar Buyer”, which awards buyers on the platform who purchase a total of 1 million dollars on the platform during their lifetime on the platform. This would be accomplished by analyzing the total amounts that are stored in the smart contracts in each user's wallet. Another example is a “Sports 100000 Collection” which is a badge awarded to users whose value of tokens in a particular collection are collectively worth 100000 dollars. Awarding of badges can be evaluated at the time of purchase when a user buys a new NFT and/or awarding of badges can be evaluated as the value of the tokens in the user's wallet goes up thereby automatically awarding the user when values of the tokens evolve over time.

In various embodiments, badges can be capable of expiring and/or of being revoked from a user. In several embodiments, badges can be revoked based on a user's failure to perform an action required to maintain ownership of a badge. Disabling, revoking, and partial disablement of NFT capabilities is disclosed in co-pending U.S. Provisional Patent Application No. 63/255,032 filed Oct. 13, 2021 titled “Non-Fungible Token Peeling” and U.S. patent application Ser. No. 17/929,894 filed Sep. 6, 2022 titled “Methods for Evolution of Tokenized Artwork, Content Evolution Techniques, Non-Fungible Token Peeling, User-Specific Evolution Spawning and Peeling, and Graphical User Interface for Complex Token Development and Simulation,” which are hereby incorporated by reference. For example, a “Win Streak” badge can be awarded to a player in a video game for winning multiple consecutive matches. When the player loses a match, the “Win Streak” badge can be removed from the player's digital identity. In another example, a “One Month Subscriber” badge is awarded to a user for enrolling in a subscription service. This badge is automatically upgraded to a “Two Month Subscriber” and “Three Month Subscriber” badge upon consecutive months of maintaining their enrollment. In some embodiments, badges can be automatically revoked when user end their enrollment to a service.

In several embodiments, badges can be awarded or augmented based on real-world achievements. Real-world achievements can include physical attendance of events held in real-world locations. For example, a musician holds a live concert and offers an exclusive “Biggest Fan” NFT badge reward to those who physically attend the event in person. In various embodiments, users' attendance can be verified, when users scan one or more NFC and/or RFID tags physically located at event venues with their mobile devices.

In several embodiments, tokens (e.g., badge tokens) can be tied to the user to whom it is assigned by associating the token to a user and/or organization identity. In some embodiments, assignments to users can include references to public keys in tokens as they are minted. In certain embodiments, identities of users can be required to be verified prior to use of token content. Use of token content can include rendering of the content. Identity verifications can be required by policies included in tokens. In various embodiments, verifications can be performed by requiring evidence of identity. Evidence of identity can be obtained and/or facilitated by wallets associated with public keys embedded in tokens for purposes of linking badges to user identities. Public keys can be pseudonyms. In accordance with some embodiments of the invention, public keys can be pseudonyms in that the public keys do not specify users' identities. In accordance with various embodiments of the invention, public keys are only used for the purposes of tying (e.g., identifying as related) tokens to wallets. In various embodiments, one or more public keys can be associated with a wallet, and/or distributed by the wallet to token issuers when the token issuer wish to tie the badge to the wallet. In many embodiments, badges can be tied to biometric identifiers of users. In a number of embodiments, biometric identifiers can be expressed using biometric tokens. Identity tokens and biometric tokens are disclosed in co-pending U.S. Provisional Patent Application No. 63/213,251 filed Jun. 22, 2021 titled “Token Creation and Management Structure” and U.S. patent application Ser. No. 17/808,264 filed Jun. 22, 2022 titled “Systems and Methods for Token Creation and Management,” which are hereby incorporated by reference. Tokens that are tied to identifiers such as public keys of wallets and/or to a user can be termed non-transferable. In some embodiments, the non-transferable features are with respect to the wallet identifier (e.g., the wallets public key and/or the user associated with the wallet by means of his or her biometrics). In several embodiments, tokens can be transferred to new instances of the same wallet on another device (e.g., in the case a user replaces his or her device used to run the wallet application with another device, such as a newer phone). In several embodiments, tokens tied to biometrics can be tied to a new expression of the same biometric (e.g., updated facial scans of one and the same user). Tying tokens to updatable biometrics is useful to perform every once in a while, as users age and their features change.

In many embodiments, users who have associated their wallets' contents with a set of fingerprints can wish to reassociate the wallets' contents to a face-print. In accordance with numerous embodiments of the invention, a second biometric (e.g., a face scan) can be verified to correspond to a first user. The first user can correspond to a first biometric (e.g., fingerprint scan). The first biometric can be to link a token to the first user. Based, the verification of the second biometric, the second biometric can be registered as linking the token to the first user.

In a number of embodiments, when face biometrics can be verified to correspond to the same user as the fingerprints do, this does not change who the user is, and accordingly, the link between the token and the user remains. In several embodiments, tokens can be tied to public keys and/or sets of biometrics, and to any of its successors, where a proof and/or evidence of identity has to be provided to update the association. The tying of property to wallets and/or biometric features can also be non-permanent and done for security purposes (e.g., as an anti-theft measure). In several embodiments, users can tie the contents of the users' wallets to wallet public keys until a reassignment of individual wallet contents (e.g., tokens) is performed. In several embodiments, performance of reassignments can require evidence of identity. Evidence of identity can be in the form of a match with a biometric token. In various embodiments, users can be protected against theft of NFTs as long as his or her biometric features cannot be forged to the wallet. In several embodiments, users can be able to sell individual NFTs when desired (e.g., by authenticating to the wallet using biometrics and reassigning the selected tokens to indicate that they no longer are tied to the public key of the wallet). In various embodiments, processes can obtain unlock keys using biometric tokens, where such unlock keys can be used to circumvent the requirement that the token be tied to the public key of the wallet. In several embodiments, policies (e.g., policies associated with tokens) can be included in NFTs. Policies can specify that an NFT is tied to the public key of the wallet and/or the key can be obtained from successful biometric authentication (e.g., of the user to the biometric token and facilitated by the wallet).

While specific systems for tying recognition badge achievements by an organization to a user's identity are described above, any of a variety of system can be utilized to tie recognition badge achievements by an organization to a user's identity as appropriate to the requirements of specific applications. In certain embodiments, components can be included in any arrangement or sequence not limited to the arrangement and sequence shown and described. In a number of embodiments, some of the above components may be execute or performed substantially simultaneously where appropriate or in parallel to reduce latency and processing times. In some embodiments, one or more of the above components may be omitted. Although the above embodiments of the invention are described in reference to tying recognition badge achievements by an organization to a user's identity, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

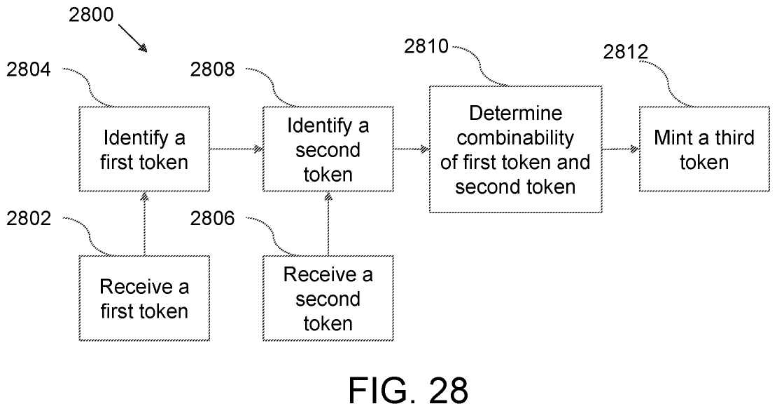

In some embodiments, two tokens from two organizations can be combined into one or more new tokens. A process for combining two tokens from two organizations into one or more new tokens is conceptually illustrated in FIG. 28. The process 2800 can receive (2802) a first token. In accordance with some embodiments of the invention, the first token is minted by a first entity (e.g., first group). The process 2800 can identify (2804) the first token. In several embodiments, the first token can be identified as having been minted by the first entity. The process 2800 can receive (2806) a second token. In some embodiments, the second token is minted by a second entity (e.g., second group). The process 2800 can identify (2808) the second token. In various embodiments, the second token can be identified as having been minted by the second entity. The process 2800 can determine (2810) a combinability of the first token and second token. The process 2800 can mint (2812) a third token. The minting of the third token can be based on the determined combinability of the first token and second token. The third token can be a derived token. In some embodiments, the first token can be associated with first characteristics, and second token with second characteristics, and/or a third with third characteristics. In some embodiments, each of the first, second, and third characteristics can enable access to different content. In accordance with various embodiments of the invention, the first entity and/or the second entity can be unaware of the existence of the first token and/or the second token. In accordance with numerous embodiments of the invention, processes (e.g., wallets) identifying the compatibility of token can trigger the minting of additional tokens to supplement or replace one or more other tokens (e.g., the first and/or second token). In some embodiments, minted tokens (e.g., the third token) can be populated in the same user's wallet. In several embodiments, tokens can be required to access content. In various embodiments, the third token can be required to access third content; the second token can be required to access second content; and/or the first token can be required to access first content. Minting the third token therefore can provide access to previously inaccessible content.

In accordance with some embodiments of the invention, recognition badge tokens are combinable. Combination can be performed for badges issued by more than one organization. For example, a student or graduate of a particular university can possess a token from their university representing their status as an alumni, and a token from a prestigious science journal for having published 25 peer-reviewed papers. A combination of the two tokens, a derived token either replacing both, or supplementing both, can exist to further a partnership between the university and the publication. Derived tokens are described in in co-pending U.S. Provisional Patent Application No. 63/213,251 filed Jun. 22, 2021 titled “Token Creation and Management Structure” and U.S. patent application Ser. No. 17/808,264 filed Jun. 22, 2022 titled “Systems and Methods for Token Creation and Management,” which are hereby incorporated by reference. In several embodiments, recognition of the available combination of the two tokens can be performed by a user wallet or similar trusted execution environment (TEE). In certain embodiments, combined tokens can bestow additional rights (e.g., access rights) to the licensee whereby a new set of policies can exist with the combined token. Tokens generated by combining tokens can be referee to as derived tokens and/or derived badges. In certain embodiments, combinations can depend on the quality levels of the associated badges, or whether they have an associated quality level or not. Badges (e.g., derived badges) can anonymize data of the badges from which the derived badge was generated.

In several embodiments, a first badge token can correspond to a first user state (e.g., a first user's graduation diploma, and can include the full name of the person). In various embodiments, a second badge that is derived (e.g., a derived badge) from the first can correspond to data obtained from the first user state (e.g., the second badge can simply state that the holder has a specified degree from a qualifying university). In many embodiments, derived badges can additionally include encrypted data that enables the verification of such a claim (e.g., encrypted references to one or more tokens that the derived token, i.e., badge, is based on).

While specific processes for combining two tokens from two organizations into one or more new tokens are described above, any of a variety of processes can be utilized to combine two tokens from two organizations into one or more new tokens as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to combining two tokens from two organizations into one or more new tokens, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

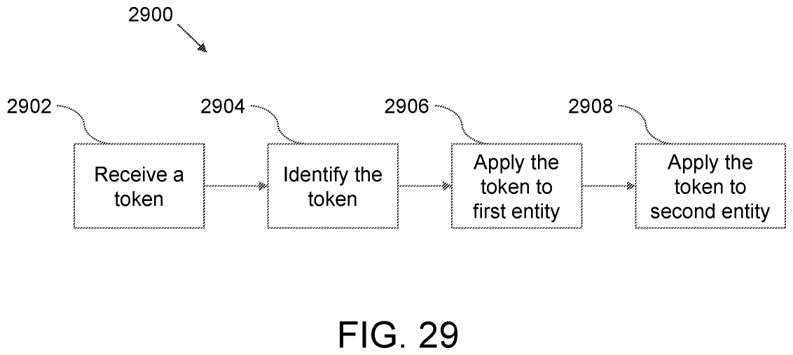

In some embodiments, recognition badges can be portable and reusable recognition badges. In several embodiments, recognition badges can be portable within two or more entities (e.g., organizations). Recognition badges can be tokens that provide access to content. An example process using portable and reusable recognition badges within two or more entities is conceptually illustrated in FIG. 29. The process 2900 can receive (2902) a token. In some embodiments, the token is minted by a first entity. The process 2900 can identify (2904) the token. In various embodiments, the token can be identified as a token minted by the first entity. In several embodiments, the token, also placed in the user wallet can represent an event associated with the user (e.g., a graduation event of the user, signifying their alumni status and enabling an alumni recognition badge on the university's various digital platforms). The process 2900 can apply (2906) the token to processes associated with the first entity (e.g., a website associated with the first entity). In accordance with some embodiments of the invention, applying the token can include displaying the token in a computer environment and/or accessing content based on the token. The process 2900 can apply (2908) the token to a second process associated with a second entity (e.g., a website associated with the second entity). In various embodiments tokens (e.g., recognition badges) can be generated by a first entity and compatible with one or more second entities. In several embodiments, users can be able to apply tokens (e.g., an alumni recognition badge) to 3rd-party platforms (e.g., social media platforms, and/or other platforms).

In some embodiments, recognition badges are reusable, and/or portable, as defined by policies associated with tokens. In several embodiments, recognition badges earned in gaming environments can be used, according to policies, in social media platforms. The policies enabling such portability can be accommodated by policies contained in token contracts. In certain embodiments, inter-platform use of tokens can be standardized. Standardized inter-platform token can include specific types of achievement tokens being portable through the use of commonly used industry standards. In accordance with various embodiments of the invention, tokens achieved in social media platforms can enable reusability, and/or redemption, within a gaming environment. In a number of embodiments, achievements in first (e.g., gaming) platforms, expressed as tokens, can be redeemable on second (e.g., social media) platforms for a particular status badge or cryptocurrency. In some embodiments, tokens (e.g., badges) can be redeemable as coupons at marketplaces. In some embodiments, original tokens can still exist after the redemption, however, the coupon portion of the token can become disabled upon use (e.g., as determined per policy). In several embodiments, a first badge can be used in the context of a second application (e.g., platform). The second application can be independent of a first application (e.g., platform). The first application can be an application that issued the first badge. In certain embodiments, the use in the context of the second application does not require the collaboration of the first application. In accordance with some embodiments of the invention, a badge earned in a first application (e.g., social media) context, (e.g., specifying that a user is among the 1% of users with the largest number of likes in a given week), can be used in a second application (e.g., a game) context. In the second context the badge can trigger an effect (e.g., the badge causes trolls in the game to be less aggressive against the user with the badge than they would have). In some embodiments, the triggered effect can reduce over time (e.g., the troll repellent functionality can wear off gradually as the badge of many social media likes ages when time passes since its issuance) and/or in response to other conditions being met. In accordance with numerous embodiments of the invention, interpretations of meanings of badges, by the second application, can be performed based on the second application accessing the token, and/or badge, and/or reading a portion that encodes a meaning associated with the badge. In some embodiments, the meaning can be expressed by a machine-readable formulation that identifies at least one qualifying criteria for being awarded the badge. In several embodiments, both meaning and quality values can be expressed in tokens to enable interpretation by second applications (e.g., the game with potentially pacifiable trolls). In various embodiments, second applications can base an applied effect on meaning and/or quality values associated with a token.

In some embodiments, users can collect badges of certain types, complementing types, and/or increasing quality values, based on a game associated with the grouping of the badges. In several embodiments, an entity (e.g., badge issuer, process, application) can create a badge bingo wherein a bingo card is associated with badges of a specified range of quality values, and each position is associated with a number or other identifier. In several embodiments, A position is occupied by a badge if the badge is associated with the appropriate number or other identifier. In several embodiments, each badge issuer can be associated with a number (e.g., based on the issuer associated public key and/or other identifier. In many embodiments, associated badges issued by such organizations can be assigned to location with a number of other identifiers matching the required value. In many embodiments, users can solve puzzles in order to determine what badges would be possible to place in what locations. In certain embodiments, badges can experience a sequence of upgrades to new levels. Upgrades can be in response to the user performing additional related tasks (e.g., such as buying their 10th and 20th items on a platform).

We refer to tokens, such as NFTs, that include badges, such as achievement-based badges or recognition-based badges, as badge tokens and vice-versa. Badge tokens can be peelable, as disclosed in co-pending U.S. Provisional Patent Application No. 63/255,032 filed Oct. 13, 2021 titled “Non-Fungible Token Peeling” and U.S. patent application Ser. No. 17/929,894 filed Sep. 6, 2022 titled “Methods for Evolution of Tokenized Artwork, Content Evolution Techniques, Non-Fungible Token Peeling, User-Specific Evolution Spawning and Peeling, and Graphical User Interface for Complex Token Development and Simulation,” which are hereby incorporated by reference.

In some embodiments, recognition badges are exchangeable, tradeable, and/or redeemable, as allowed by policy. In several embodiments, achievements made by a member of a group (e.g., a youth scout organization) can receive a recognition badge in the form of a digital token. In certain embodiments, the token can be exchangeable for another badge, perhaps upon reaching a more elevated achievement. In many embodiments, badges can be exchangeable for goods or services based upon policy. In various embodiments, the token can continue existing or can cease to exist after exchange. In various embodiments, a member (e.g., scout) can exchange a badge for a reward (e.g., 2 tickets to a local movie theater). The member (e.g., scout) can see the token transfer to the theater and the theater can be able to return the token to the group (e.g., the scouting organization) in exchange for a business recognition of supporting the group (e.g., the scouting organization). In certain embodiments, recognition badges from one social media platform can be exchangeable for similar recognition badges from other platforms. In certain embodiments, a badge from an airline can be minted to award a frequent flyer. Badges can enable, per policy, access to frequent flyer tokens from other entities (e.g., partners or competing entities). One skilled in the art will recognize that recognition badges are but one type of token, and that the embodiments described throughout this disclosure can apply to other types of tokens, such as loyalty tokens. Badge tokens can be used as discount coupons or as frequent flier miles are used.

In various embodiments, processes can enable the semi-permanent and permanent storage of tokens on public decentralized networks. In several embodiments, publicly stored tokens can be perceived as more useful and valuable than those controlled solely by the issuer. In several embodiments, tokens from two or more issuers can interact within a user's wallet or within 3rd-party trusted execution environments. In accordance with various embodiments of the invention, badges can be publicly audited since the badges' existence can be determined based on accessing a database (e.g., a blockchain). In several embodiments, auditing can be important to safeguard against badge-based inflation and/or abuse based on reckless minting of badges. In several embodiments, public verifiability can be implemented in a variety of manners. Public verifiability can be implemented by only permitting badges with serial and/or edition numbers within pre-specified ranges. In certain embodiments, systems can be configured to not permit duplication of the same serial numbers. In several embodiments, automated audit capabilities, whether performed by the issuer or a 3rd-party can also help to validate the issuer's actions versus stated policy. In various embodiments, public verifiability can extend to validation of the issuance of badges per stated company policies. In accordance with some embodiments of the invention, public verifiability can be used to verify that a stated quality measure is correct, or at least plausibly correct based on probabilistic verification methods.

In several embodiments, badges controlled and contained within publicly available decentralized networks can be used; in user gaming profiles; within emails and/or other communications; to demonstrate achievement; and/or status. In certain embodiments, badges express loyalty, recommendations, and/or reviews.

While specific processes for using portable and reusable recognition badges within two or more entities are described above, any of a variety of processes can be utilized to use portable and reusable recognition badges within two or more entities as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to using portable and reusable recognition badges within two or more entities, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

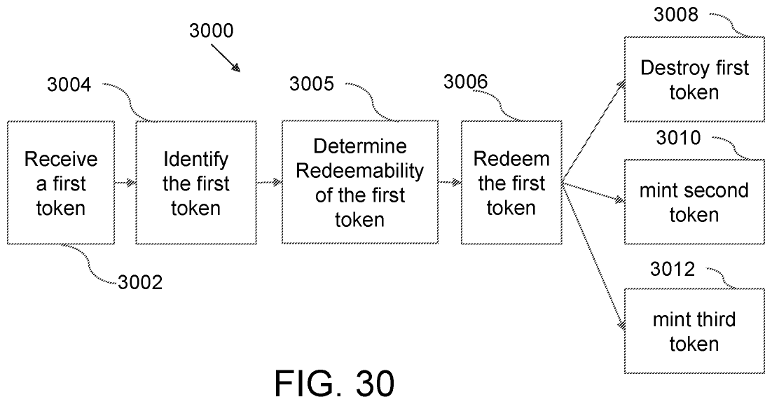

In a number of embodiments, tokens can be redeemable recognition badges. An example process for using redeemable recognition badges in the form of tokens is conceptually illustrated in FIG. 30. The process 3000 can receive (3002) a first token. In some embodiments, the first token can be a token minted by a first entity (e.g., organization and/or group). The process can identify (3004) the first token. In several embodiments, the first token can be identified as having been minted by the first entity. The process 3000 can determine (3005) the redeemability of the first token. In several embodiments, the redeemability of the first token can be based on a condition being satisfied. In many embodiments, the condition can be the passage of time, the condition can be based on blockchain events, and/or the condition can be defined by a policy. The process 3000 can redeem (3006) the first token. In certain embodiments, tokens, which have redeemable characteristics can be redeemed by users, wallets, and/or 3rd-party systems. In accordance with numerous embodiments of the invention, redeemability characteristics can be dependent upon policies. The process 3000 can perform the redemption of the first token by destroying (3008) the first token; by minting (3010) a second token; and/or by minting (3012) a third token. In some examples, two new tokens may be created, however, there are a variety of possible outcomes, such as destruction of token A, the deprecation of token A, the creation of one or more new tokens, and/or the extraction of a redeemed item from token A (e.g., such as redeeming a recognition badge token for a cinema ticket, as described elsewhere herein). In accordance with embodiments of the invention, different tokens can enable access to different content.

While specific processes for using redeemable recognition badges in the form of tokens are described above, any of a variety of processes can be utilized to use redeemable recognition badges in the form of tokens as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to using redeemable recognition badges in the form of tokens, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

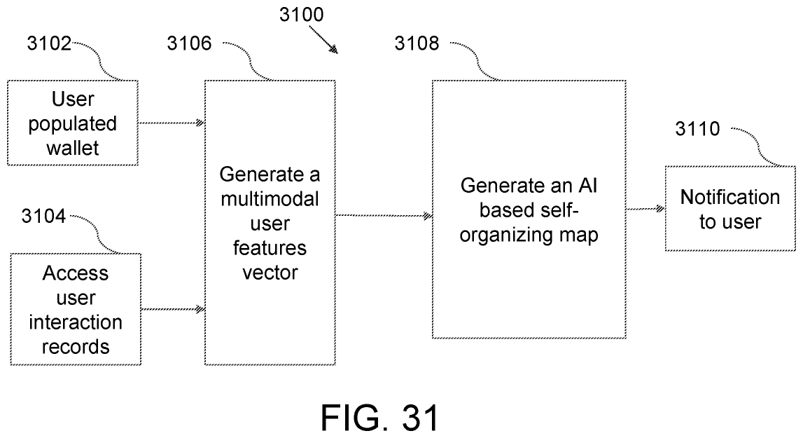

In some embodiments, processes can predict potential future badge awards. An example process for the prediction of potential future badge awards is conceptually illustrated in FIG. 31. The process 3100 can populate (3102) a user wallet and/or receive a populated user wallet. In accordance with some embodiments of the invention, user wallets can be monitored. In several embodiments, processes can record user interactions with the applicable platform. In certain embodiments, monitoring can include collecting user data. User data can be collected from the user wallet and/or the user collection of smart contracts. In various embodiments, the data gathered can be an aggregate amount of time on the site, monthly levels of activity on the site, the number of comments a user creates, and/or other information. The process 3100 can access (3104) user interaction records. The process 3100 can generate (3106) a multimodal user feature vector based on one or more data elements (e.g., N dimensions). Data elements can include data associated with wallets (e.g., a user's wallet), smart contracts (e.g., smart contracts associated with the wallet and/or the user) and user activities (e.g., as described elsewhere herein). In several embodiments, feature vectors can use averages, changes in positions, and/or other mathematical summarizations to simplify the signals of each data element. While some processes discussed describe generating a multimodal feature vector for a user, related processes can similarly generate multimodal feature vectors for tokens (e.g., badges). The process 3100 can generate (3108) an AI based self-organizing map. In many embodiments, AI based self-organizing maps can describe tokens (e.g., badges) which each have pre-set feature vectors that are organized in N dimensions. The self-organizing maps can be constantly evolving as new badges are created and constantly recalculated using an AI self-organizing methodology. In many embodiments, The AI based self-organizing map identifies badges that match to users based on the multimodal feature vectors of the users and/or the badges. In accordance with embodiments of the invention, user feature vectors (e.g., as created in step 3106) can be inserted into the AI based self-organizing map and using a k-nearest neighbor methodology, the closest badge achievable can be found in N dimensional space. The process 3100 can notify (3110) a user of a selected badge. In some embodiments, processes can use the selected predicted badge and/or the feature vectors from the user and/or the badge to find the difference in what was required to earn the badge. In certain embodiments, the user can be notified what they can do to earn a badge.

In some embodiments, processes can predict future potential badges a user is eligible and/or likely to achieve and display them to the user. In several embodiments, processes can store interactions of users as elements in smart contracts. In various embodiments, processes can use a K nearest neighbor AI technique on the calculated confidence intervals to determine which badges are attainable in the near future as described elsewhere herein. In certain embodiments, processes can probabilistically determine which potential badges to display. In certain embodiments, a system can calculate a 40% likelihood that a user with a given history can achieve the goal by spending $20,000 after only spending $10,000 and a user that is $5,000 from a goal of $100,000 can be 90% likely to achieve the goal. In accordance with embodiments of the invention, processes (e.g., wallets) can document what is required to achieve these badges and automatically document the badges in a notification to the user via email, text and/or an in-app notification. In some embodiments, a process could notify the top 100 creators in November that they are in contention to win the “Top 10 November Creator” token. In various embodiments, users who spend $900,000 dollars on the platform overtime can be notified that they only have to spend $100,000 more to earn the “1 Million Dollar Buyer” Badge.

In many embodiments, predictions, like whether a user is likely to spend a certain amount within the month, are relative to the user alone, and can be based on historical purchases, recent purchases, recent browsing activities, and/or remaining amounts to be spent. In accordance with various embodiments of the invention, predictions are relative to other users as well as to the user for which the prediction is offered. In various embodiments, predictions of whether a given user will end up having made purchases that end up being among the 25% fastest appreciating purchases during the month is based on the user's actions, and/or predicted actions, as well as actions of other users, and/or their predicted actions, and/or on a general prediction of appreciation of NFTs that have appreciated well during the portion of the month that has already elapsed. Predictions can be performed using a statistical engine, a machine learning algorithm, and/or artificial intelligence system.

While specific processes for the prediction of potential future badge awards are described above, any of a variety of processes can be utilized to predict potential future badge awards as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to the prediction of potential future badge awards, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A device configured to implement a distributed ledger capable of immutably recording state data to tokens, the device comprising:
a network interface;
memory; and
a processor, the processor configured to:
obtain a token, the token comprising:
a token description, the token description based on state data captured from an application; and
an access policy comprising a set of access rights, the set of access rights enabling access to content, wherein the set of access rights and the content are based on the state data captured from the application;
render the token description;
receive a user input;
initiate an action based on the token description and the user input, wherein the action comprises accessing the content using the set of access rights associated with the token;
generate a transaction record, the transaction record comprising an indication of the action and the token; and
broadcast the transaction record, the transaction record configured to be incorporated into a ledger entry, wherein the ledger entry is capable of being used to compute a challenge for securely adding the ledger entry to a distributed ledger using a cryptographic system.

2. The device of claim 1, wherein the token is obtained by generating the token.

3. The device of claim 1, wherein the token is obtained by receiving the token.

4. The device of claim 1, wherein the processor is further configured to detect a trigger.

5. The device of claim 1, wherein the processor is further configured to detect a trigger, and wherein the action is initiated further based on the detection of the trigger.

6. The device of claim 1, wherein the processor is further configured to detect a trigger, wherein the trigger is satisfied based on an application state.

7. The device of claim 1 wherein the processor is further configured to detect a trigger, and the trigger is identified using a proximity determination.

8. The device of claim 1 wherein the processor is further configured to detect a trigger, and the trigger is identified using a proximity determination proximity that is based on at least one item selected from a list of a GPS location being read, a Bluetooth radio signal being detected, or detection using a near field communication (NFC) sensor.

9. The device of claim 1 wherein the processor if further configured to detect a trigger, and wherein the trigger is a user-initiated request.

10. The device of claim 1 wherein the processor if further configured to detect a trigger, and wherein the trigger is an in-game achievement.

11. The device of claim 1, wherein the state data represents a game highlight segment.

12. The device of claim 1, wherein the state data represents a game achievement.

13. The device of claim 1, wherein the state data comprises a game configuration.

14. The device of claim 1, wherein capturing of state data comprises accessing a record associated with a game character.

15. The device of claim 1, wherein the access policy further comprises a public key associated with a user allowed to access at least a portion of the content.

16. The device of claim 1, wherein the access policy further comprises a public key associated with a user allowed to enable access to at least a portion of the content.

17. The device of claim 1, wherein the access policy further comprises an indication of a role of a user allowed to access at least a portion of the content.

18. The device of claim 1, wherein the content is rendered in an interface of a social networking application.

19. The device of claim 1, wherein the content is rendered in an interface of a wallet application.

20. The device of claim 1, wherein a log is generated in response to the access of the content.
